(19) United States
(12) Patent Application Publication
(10) Pub. No.: US 2009/0037332 A1
(43) Pub. Date: Feb. 5, 2009

(54) Systems and Methods for Processing Banking Transactions

(76) Inventors: Janice Cheung, Arcadia, CA (US); Nigel Feasey, Ladera Ranch, CA (US); Sally Fraustro-Fairfield, Whittier, CA (US); Richard Gunderson, II, San Clemente, CA (US); Sergey Kats, Los Angeles, CA (US); Anthony Mays, Norwalk, CA (US); Bryan Walley, Altadena, CA (US); Arulanandu Michael, Glendale, CA (US); Rod Shahinian, Los Angeles, CA (US); Kai Man Kelvin Tse, San Marino, CA (US)

Correspondence Address: LOEB & LOEB, LLP, 321 NORTH CLARK, SUITE 2300, CHICAGO, IL, 60610-4746, US

(21) Appl. No.: 12/183,509

(22) Filed: Jul. 31, 2008

Related U.S. Application Data
(60) Provisional application No. 60/953,101, filed on Jul. 31, 2007.

(51) Int. Cl. G06Q 40/00

(52) U.S. Cl. 705/42

(57) ABSTRACT

A system and method for providing an efficient and robust interface that allows banking transactions to be processed by an online banking system and third party accounting software packages via a single user point of entry. The system is configured to receive a transaction request from a third party accounting software, the transaction request including one or more transactions; verify, based on information stored in a first database, that the transaction request is from a valid source; store information regarding the one or more transactions from the transaction request in a second database; process the one or more transactions; and provide a response to the third party accounting software indicating a status of at least one transaction in the transaction request.

### TECHNICAL FIELD OF THE INVENTION

This disclosure relates generally to banking systems and, more particularly, to systems and methods for processing banking transactions.

### BACKGROUND

Banking technologies that permit users to request banking transactions using an Internet browser are well known. These systems also typically maintain a record of each individual's banking transactions, thus permitting each individual to review and/or manage his/her account using a website affiliated with the particular bank.

Such websites, however are not generally suited for management of multiple accounts, as is necessary for business managers that often manage a large number of accounts. Instead, to manage information regarding their clients' accounts, business managers typically utilize various third party accounting software (TPAS) packages, such as those from Zenith or Datafaction. As a result, business managers must currently enter banking transactions for each account both into the online banking system (to request a transaction) as well as into the TPAS (to record information regarding the transaction). This both inefficient and increases the likelihood of clerical errors. Accordingly, there is a need for a system and method that permits banking transactions to be processed by online banking systems and TPAS using a single point of entry.

### SUMMARY OF THE INVENTION

The present invention, in accordance with one embodiment of the invention, includes a system having an entitlements database, a transaction assessment engine, a transaction database, and a transaction processing engine. The entitlements database is configured to store company, client, account, and user information, as well as information identifying associated third party accounting software sites.

The transaction assessment engine is configured to receive a transaction request from a third party accounting software site, where each transaction request including one or more banking transactions, validate the transaction request, and provide one or more status messages to the third party accounting software regarding the status of the one or more banking transactions. The transaction database is in communication with the transaction assessment engine and is configured to store information regarding the one or more banking transaction included in the transaction requests. The transaction processing engine is configured to processing the one or more banking transactions.

The system may also include a bank hosted website that is configured to permit users to access the system and to, among other things, update information stored in the entitlements database.

In another aspect, the present invention may also include a method for processing financial transactions comprising receiving a transaction request from a third party accounting software, the transaction request including one or more transactions; verifying, based on information stored in a first database, that the transaction request is from a valid source; storing information regarding the one or more transactions from the transaction request in a second database; processing the one or more transactions; and providing a response to the third party accounting software indicating a status of at least one transaction in the transaction request.

### BRIEF DESCRIPTION OF THE FIGURES

Various embodiment of the invention are now described, by way of example only, with reference to the accompanying figures.

FIG. 1 illustrates one embodiment of a system in accordance with the present invention.

FIG. 2 shows one embodiment of a schema for an entitlements database in accordance with the present invention.

FIG. 3 shows one embodiment of a schema for a transaction database in accordance with the present invention.

FIG. 4 shows one embodiment of a method for processing banking transaction requests in accordance with the present invention.

FIG. 5 shows one embodiment of a method for processing individual banking transactions in accordance with the present invention.

FIG. 6 shows one embodiment of a release request message in accordance with the present invention.

FIG. 7 shows one embodiment of a home page screen in accordance with the present invention.

FIG. 8 shows one embodiment of a search results screen in accordance with the present invention.

FIG. 9 shows one embodiment of a company details screen in accordance with the present invention.

FIG. 10 shows one embodiment of an accounts products screen in accordance with the present invention.

FIG. 11 shows one embodiment of a company users summary screen in accordance with the present invention.

FIG. 12 shows one embodiment of a company user details screen in accordance with the present invention.

FIG. 13 shows one embodiment of a company overrides screen in accordance with the present invention.

FIG. 14 shows one embodiment of a linked clients screen in accordance with the present invention.

FIG. 15 shows one embodiment of a client details screen in accordance with the present invention.

FIG. 16 shows one embodiment of a client user screen in accordance with the present invention.

FIG. 17 shows one embodiment of a client user details screen in accordance with the present invention.

FIG. 18 shows one embodiment of a client overrides screen in accordance with the present invention.

FIG. 19 shows one embodiment of an accounts screen in accordance with the present invention.

FIG. 20 shows one embodiment of an account details screen in accordance with the present invention.

FIG. 21 shows one embodiment of an inactive accounts screen in accordance with the present invention.

FIG. 22 shows one embodiment of an inactive account details screen in accordance with the present invention.

FIG. 23 shows one embodiment of an account user summary screen in accordance with the present invention.

FIG. 24 shows one embodiment of an account user details screen in accordance with the present invention.

FIG. 25 shows one embodiment of a queue management screen in accordance with the present invention.

FIG. 26 shows one embodiment of an ACH management screen in accordance with the present invention.

FIG. 27 shows one embodiment of an automatic book transfer management screen in accordance with the present invention.

FIG. 28 shows one embodiment of a manual book transfer management screen in accordance with the present invention.

FIG. 29 shows one embodiment of an automatic stop payment management screen in accordance with the present invention.

FIG. 30 shows one embodiment of a manual stop payment management screen in accordance with the present invention.

FIG. 31 shows one embodiment of an automatic domestic wire transfer management screen in accordance with the present invention.

FIG. 32 shows one embodiment of a manual domestic wire transfer management screen in accordance with the present invention.

FIG. 33 shows one embodiment of a domestic wire bridge management screen in accordance with the present invention.

FIG. 34 shows one embodiment of a client movement screen in accordance with the present invention.

FIG. 35 shows one embodiment of a site ID details screen in accordance with the present invention.

FIG. 36 shows one embodiment of a reports intro screen in accordance with the present invention.

FIG. 37 shows one embodiment of an accounts report screen in accordance with the present invention.

FIG. 38 shows one embodiment of an audit log report screen in accordance with the present invention.

FIG. 39 shows one embodiment of a queue status report screen in accordance with the present invention.

FIG. 40 shows one embodiment of a transactions report screen in accordance with the present invention.

FIG. 41 shows one embodiment of a status history report screen in accordance with the present invention.

FIG. 42 shows one embodiment of a products report screen in accordance with the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present invention. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION OF THE INVENTION

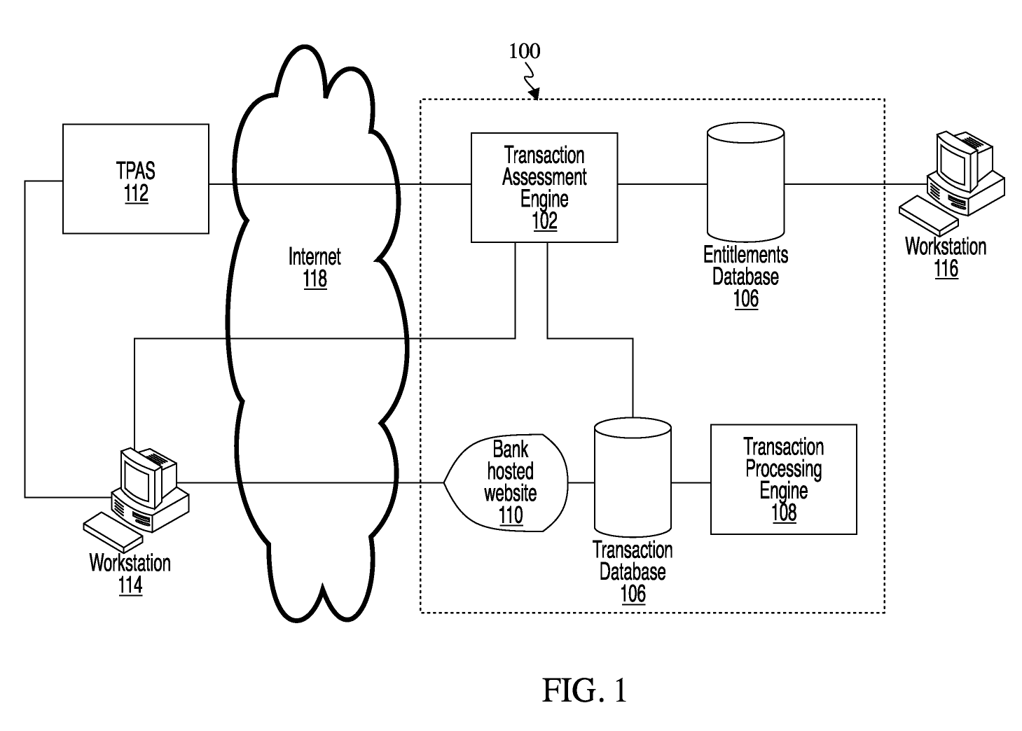

The present invention provides a system and method for providing an efficient and robust interface that allows banking transactions to be processed by an online banking system and Third Party Accounting Software (TPAS) packages via a single user point of entry. FIG. 1 illustrates one exemplary embodiment of a system 100 in accordance with the present invention. In this embodiment, the system 100 includes a transaction assessment engine 102, an entitlements database 104, a transaction database 106, a transaction processing engine 108, and a bank hosted website 110 (which may be stored on one or more web servers).

The system 100 is configured to communicate and interact with a third party accounting software (TPAS) 112 that maintains a record of financial transactions for multiple accounts. More particularly, as will be discussed in more detail below, the system 100 is configured to receive transaction requests from the TPAS 112, and to transmit status information for requested transactions to the TPAS. In one embodiment, the system 100 communicates with the TPAS 112 via the internet 118, more particularly HTTP or FTP, and even more particularly HTTPS or SFTP in order to provide secured communications. However, any type of communication protocol may be used. Examples of well-known TPAS products include those from Datafaction and Zenith, although it should be understood that the system 100 may be configured to communicate with any TPAS.

Individuals, such as account managers, administrators, etc. (generally referred to herein as “users”), may also interact with the system via workstations 114 or 116. In the embodiment shown in FIG. 1, workstation 114 is configured to communicate with the system 100, and more particularly the bank hosted website, via the internet 118. Workstation 116, on the other hand, is generally meant for use by administrators and is therefore configured to communicate directly with the system 100, and more particularly the entitlements database, using a WAN or LAN connection. Of course, it is understood that other types of connections may also be used to provide communications between a workstation 114 or 116 and the system 100. It should also be understood that neither workstation 114 or 116 is meant to be limited to a particular type of device. For example, either may be a desktop computer, a portable computer, an internet-enabled PDA or cellular phone, or the like.

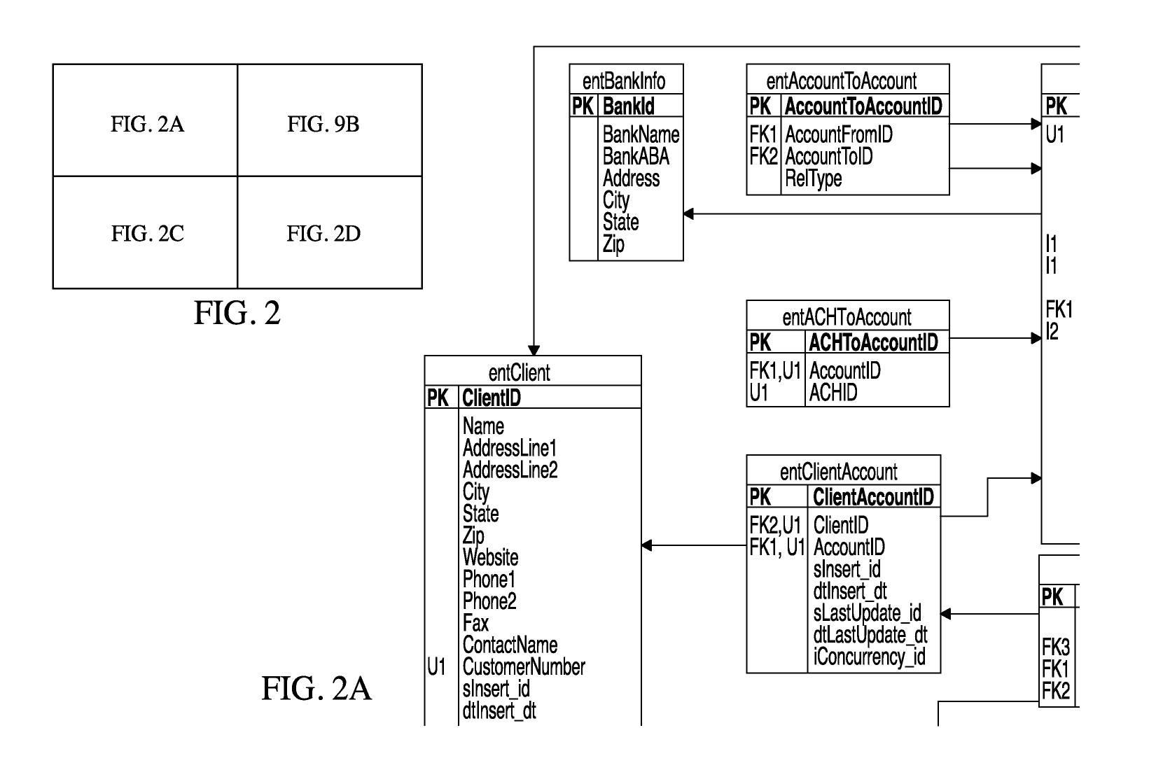

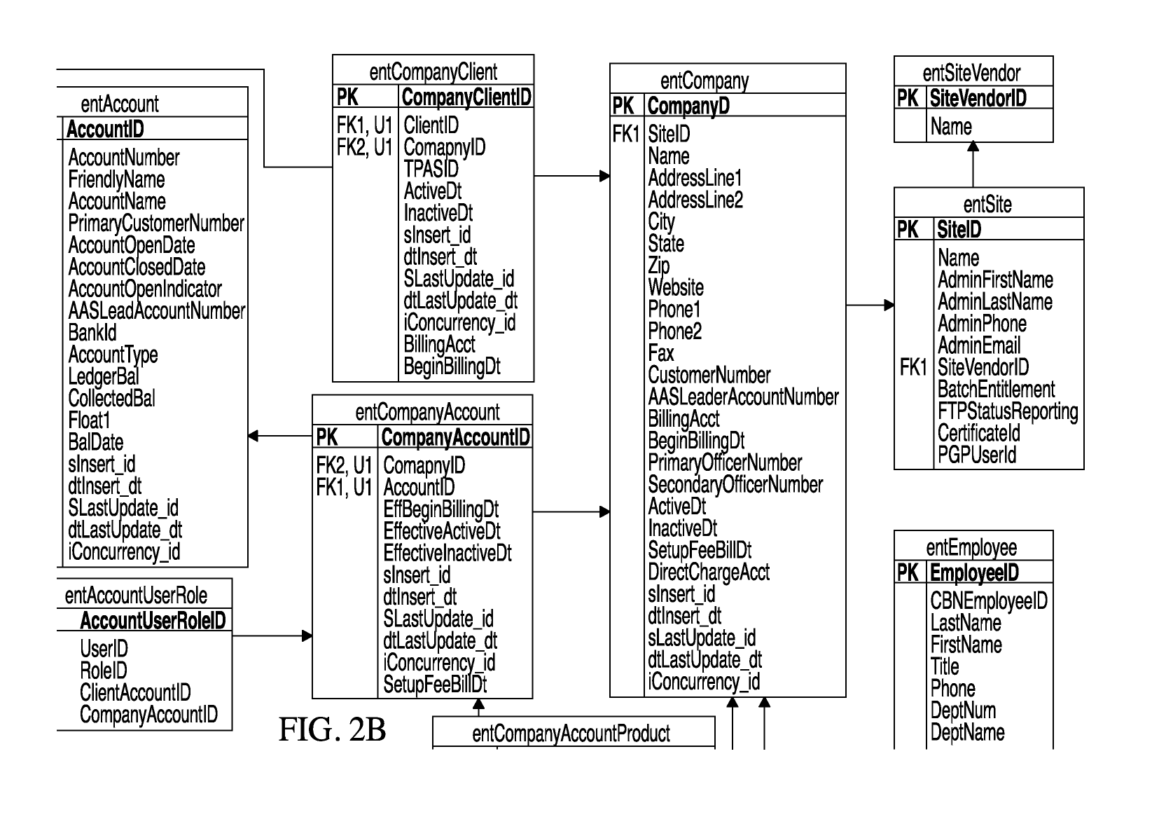

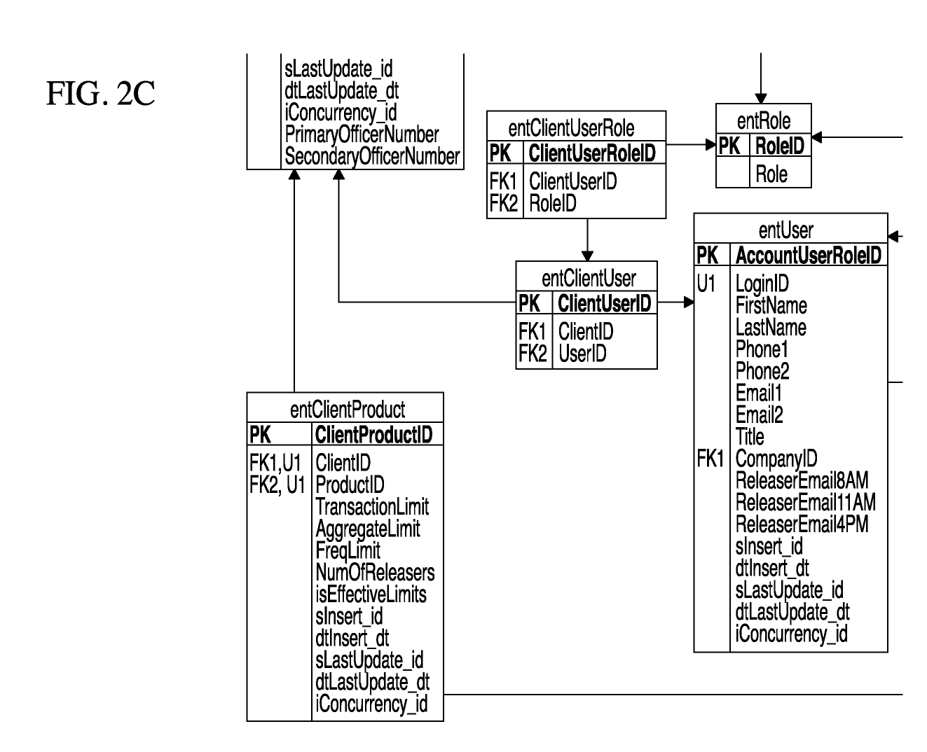

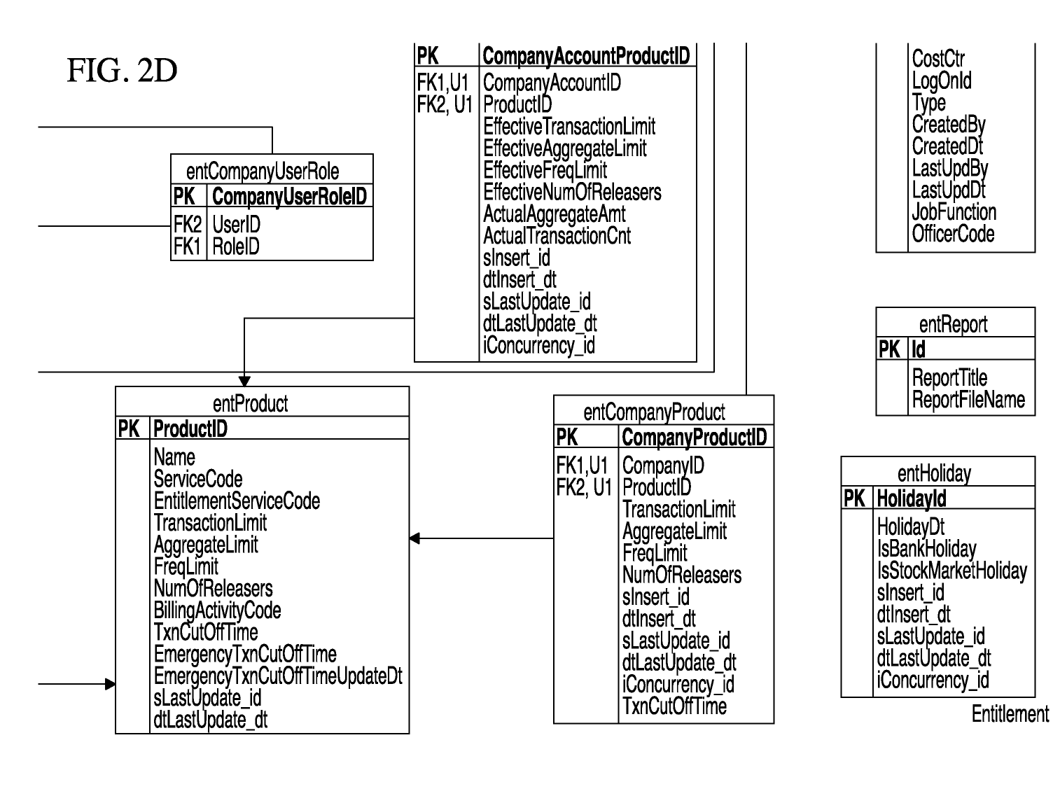

In operation, the entitlement database 104 is configured to maintain and store the records for each account, including client information (i.e., the entity that owns an account), indications of the permitted transactions for the account (also referred to herein as “products” and/or “services”), company information that identifies the business having a TPAS installation configured to initiate transactions, and a site ID to identify a particular TPAS. In the embodiment described herein, a plurality of clients may be attributed to a single company. A single site ID may also correspond to only a single company (such as typically the case with business entities utilizing Datafaction TPAS) or multiple companies (such as typically the case with business entities utilizing Zenith TPAS). As will be discussed in more detail below, the entitlements database 104 may also include user information to identify individuals that have authority to conduct financial transactions for a given account. One exemplary schema for the entitlements database is illustrated in FIG. 2, although it is understood that various schema may be used so long as the relevant information is capable of being stored.

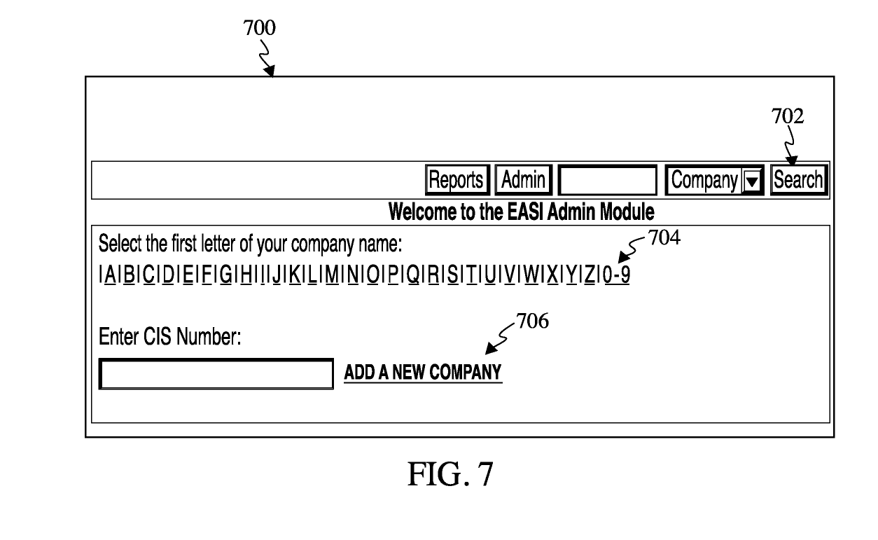

The information stored in the entitlements database 104 may be input using various methods. In one embodiment, the information for the entitlements database 104 may be input by an account manager (using, for example, workstation 114) via the bank hosted website 110. In another embodiment, information for the entitlements database 104 may be input by an administrator (using, for example, workstation 114 or 116). Specific examples of web interface screens from a bank hosted website 110 that may be utilized for inputting and maintaining information in the entitlements database 104 will be discussed in greater detail with reference to FIGS. 7 through 42.

The transaction assessment engine 102 is configured to validate, by reference to the entitlements database 104, transaction requests (such as, for example, transfers, stop payments, ACH transactions, and status inquiries) received from a TPAS 112. For example, in one embodiment, the transaction assessment engine 102 may be configured to validate the source of any transaction requests received from the TPAS, and to verify that the account corresponding to the transaction request is entitled to perform the requested transaction. As will be discussed in more detail below, the transaction assessment engine 102 may also be configured to determine whether a transaction request requires a release (i.e., an additional confirmation or approval by a user before performing the transaction request).

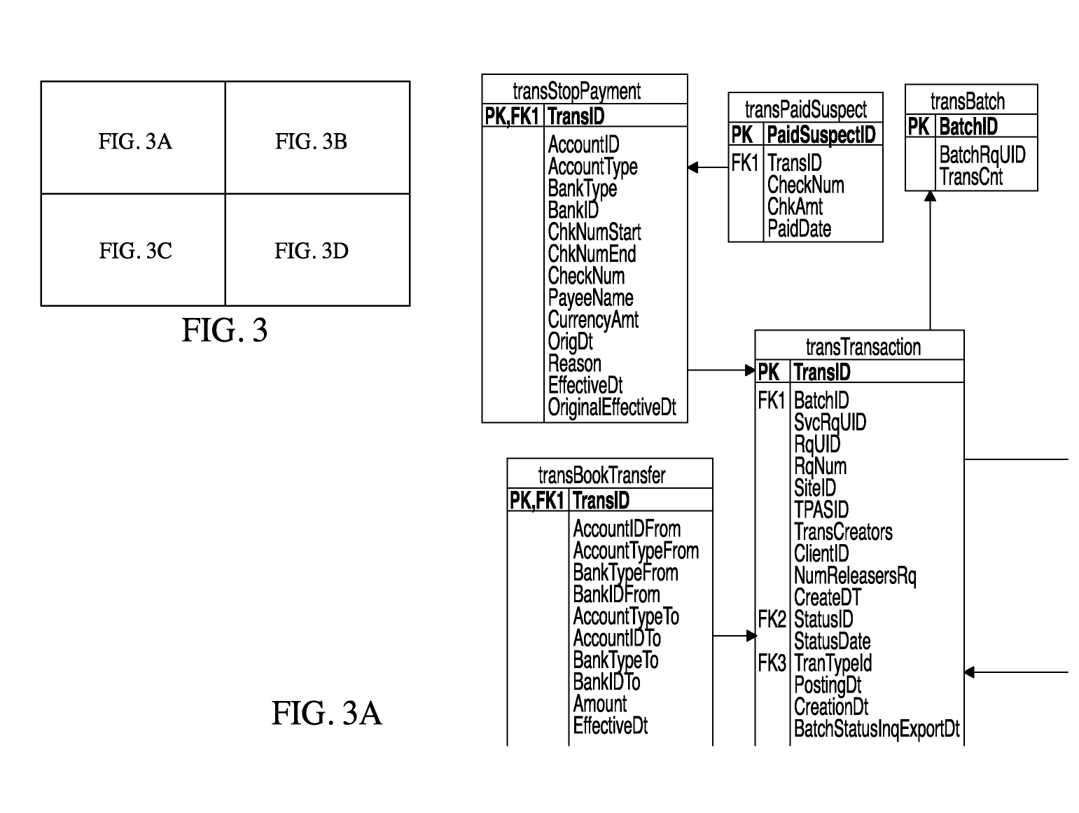

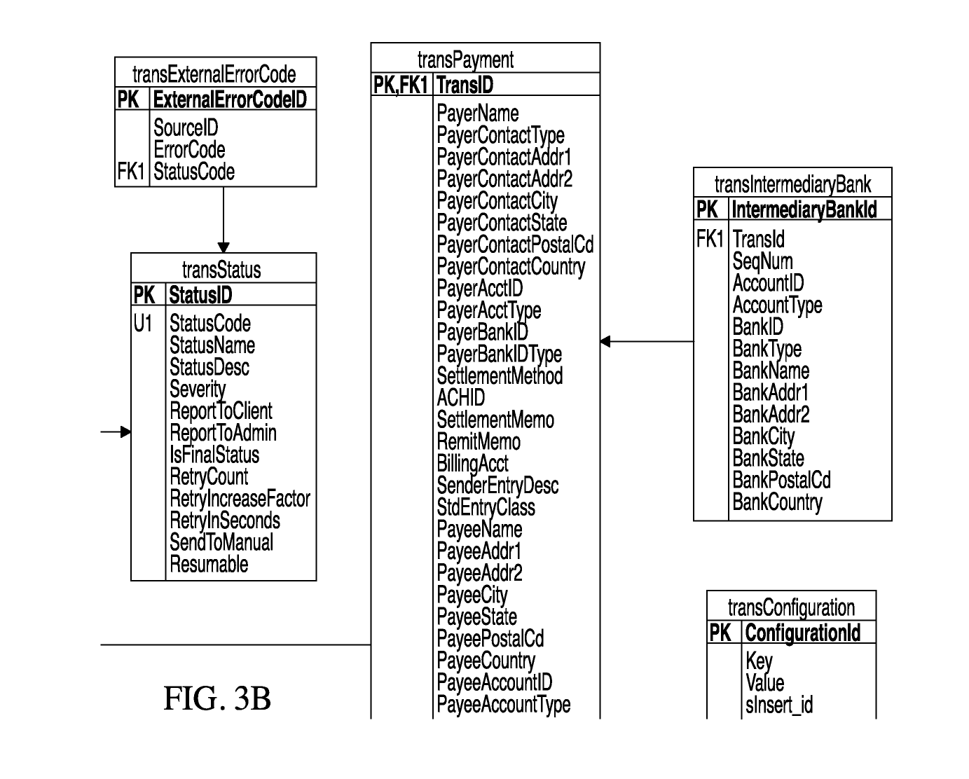

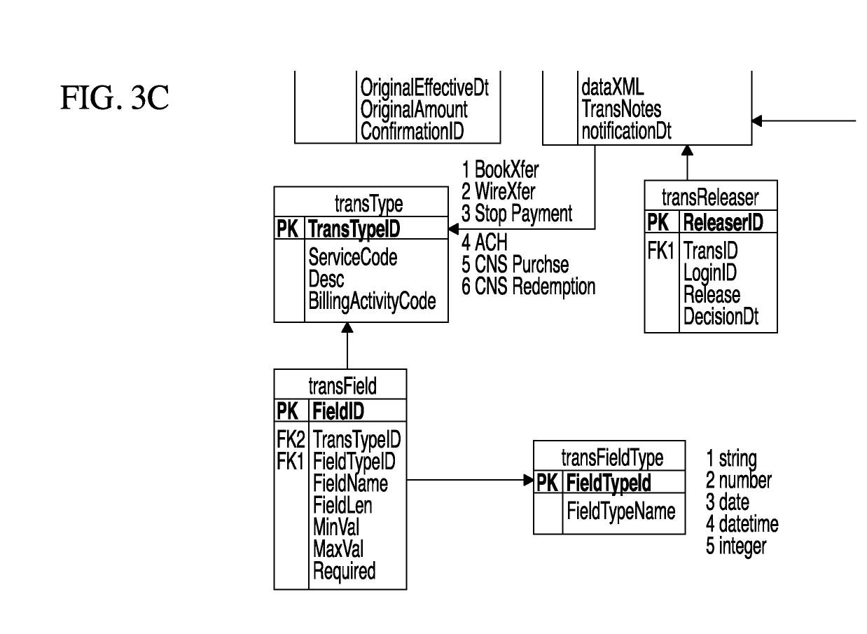

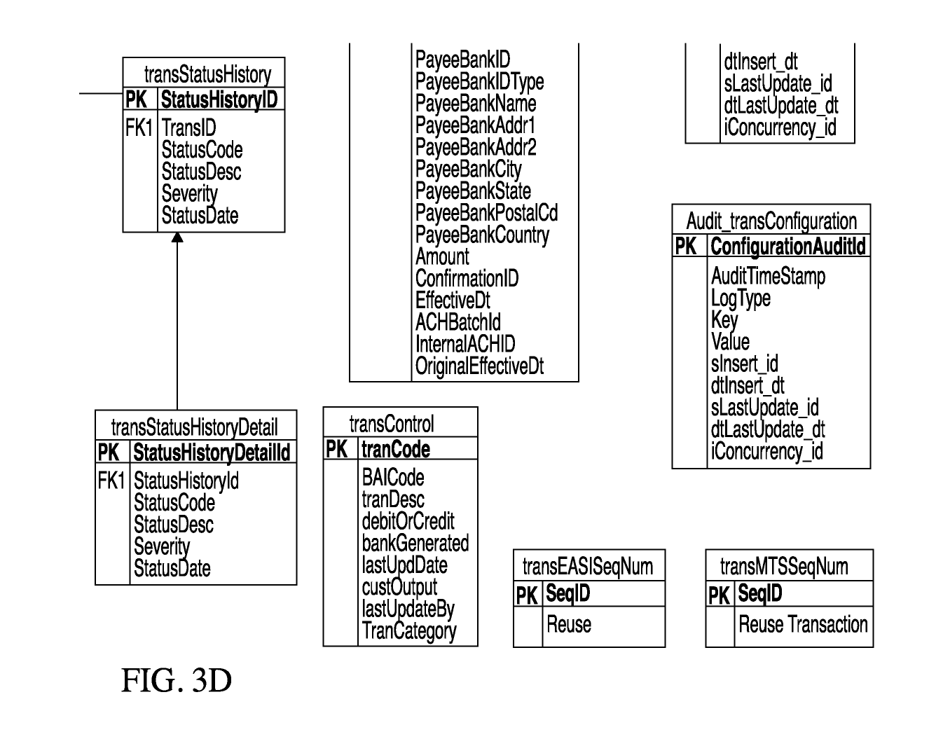

The transaction database 106 maintains a record of all requested transactions as well as the current status and/or status history of the transaction requests. The transaction database 106 may also be used to log system and transaction errors in order to evaluate the system and identify recurring problems. The transaction database 106 may further be used to record system related parameters such as the start or stop times of various services. One exemplary schema for the transaction database 106 is illustrated in FIG. 3, although it is understood that various schema may be used.

The transaction processing engine 108 performs the various banking transactions that are requested from the TPAS 112. Various types of transaction processing engines may be used depending on the nature of the requested transaction. Thus, it is understood that while the transaction processing engine 108 is illustrated as a single entity, it may be comprised of multiple different transaction processing engines. For example, an eFunds transaction processing engine may be used for processing ACH transaction; Connectware and Metavante may be used for processing book transfers and stop payments; and MTS may be utilized for wire transfers. Such products and services are well known in the art and are therefore not discussed in any further detail herein.

Practitioners skilled in the art will recognize that the system may include various elements not illustrated in FIG. 1. For example, while only one instance of each of the transaction assessment engine 102, entitlements database 104, transaction database 106, and transaction processing engine 108 are illustrated, it should also be understood that each of these elements may be distributed among a plurality of components or devices, in one or more geographic locations. Similarly, while only a single TPAS server 112, user workstation 114 and administrator workstation 116 are illustrated for purposes of clarity, it should be understood that the system 100 is capable of interfacing with multiple TPAS installations, user workstations, and administrator workstations.

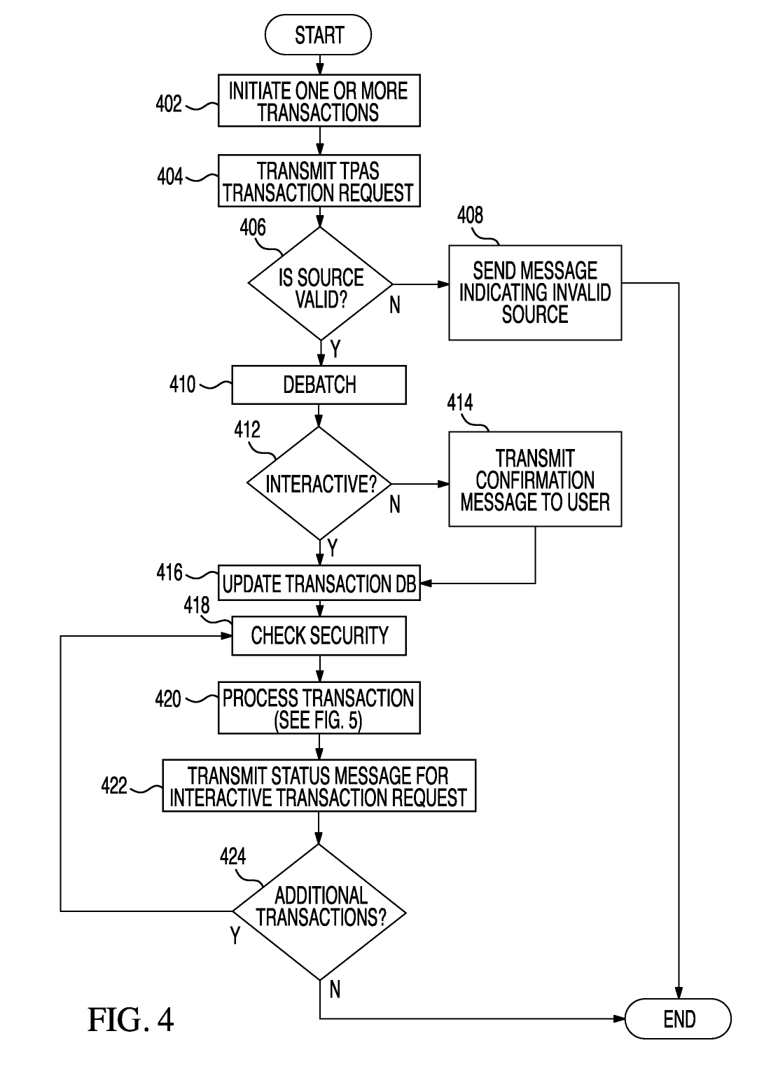

FIG. 4 illustrates one exemplary embodiment of a method for processing TPAS transaction requests in the system of FIG. 1. In step 402, a user initiates one or more transactions for one or more clients and/or accounts. In one embodiment this may be accomplished by the user accessing the TPAS 112 via the workstation 114 and identifying one or more desired transactions to be initiated for one or more clients and/or accounts being managed by the TPAS 112. The various types of banking transactions that may be initiated may include wire transfers, book transfers, stop payments, ACH transactions, status inquiries, and the like. The interface and protocols used to initiate a transaction in the TPAS is specific to the particular TPAS being utilized and is therefore not discussed in any further detail herein.

In step 404, a TPAS transaction request reflecting the one or more user initiated transactions is transmitted from the TPAS 112 to the transaction assessment engine 102. As noted above, the TPAS transaction request is preferably transmitted using HTTP or FTP, and more particularly HTTPS or SFTP, although other communication protocols may also be used. In one embodiment, to allow for interoperability between various types of systems, the TPAS 112 may be configured to transmit the transaction request in a format complying with Extensible Markup Language (XML) Interactive Financial eXchange Forum (IFX) standards. However, other formats may also be used.

After receiving a TPAS transaction request, the transaction assessment engine 102 validates the TPAS transaction request to confirm that the transaction request is from a valid source in step 406. For example, in one embodiment, the transaction assessment engine 102 may be configured to confirm that the TPAS transaction request is from a valid source by referencing information that has been previously stored in the entitlements database 104 to confirm that the TPAS transaction request was received from a registered TPAS 112 installation.

If the TPAS transaction request is not from a valid source, the TPAS transaction request is not processed and a message may be transmitted back to the TPAS in order to indicate as such in step 408. The message may be transmitted to the TPAS using HTTP or FTP, or more particularly HTTPS or SFTP. A separate message may also be provided to a user by other means to indicate that the TPAS transaction request was not valid. For example, this separate message may be in the form of an email, text, voice message or any other type of communication. The message may also be made accessible to the user via a message board or communications inbox on the bank hosted website. It should also be understood that transmission of such a message need not be limited to, or even include, the user that requested the transaction. Preferences established for a company, client, or account (preferably stored in the entitlements database 104) may identify one or more individuals that are to receive messages regardless of the user that actually initiated the transaction.

If the TPAS transaction request is valid, the process proceeds to step 410 where the TPAS transaction request is debatched into individual transactions. Of course, if the TPAS transaction request includes only a single transaction, it is understood that this step may not be necessary.

The transaction assessment engine 102 determines whether a TPAS transaction request is interactive in step 412. For purposes of this disclosure, a TPAS transaction request is considered interactive if it can be fully processed and a final status can be returned within a single session. Examples of interactive TPAS transaction requests may include single financial transactions that do not require a release, inquiries for information stored in the entitlement database, or inquiries regarding the status of a transaction. On the other hand, examples of non-interactive TPAS transaction requests may include batches of multiple transactions, ACH transactions, and any transactions requiring a release (which will be explained in more detail below). Whether a TPAS transaction request is interactive may also depend on the communication protocol utilized to transmit the TPAS transaction request. For example, in one embodiment, due to the nature of the communication protocols, only transaction requests transmitted using HTTP, as opposed to FTP, may be considered interactive.

If the TPAS transaction request is determined not to be interactive, a confirmation message is transmitted to the TPAS acknowledging receipt of the TPAS transaction request in step 414. Since a final status cannot be confirmed within a single session for the non-interactive TPAS transaction request, this confirmation message serves to confirm that the requested transaction or transactions have been received and validated by the system 100. As above, a separate message confirming receipt of the TPAS transaction request may also be provided to a user using email, voice message, text message, voice message, via the bank hosted website, or any other known method. This message may also be provided to any user identified as having permission to receive such messages. Regardless of whether the transaction request is determined to be interactive, the process proceeds to step 416.

In step 416, the transaction database 106 is updated with information regarding each requested transaction from the TPAS transaction request. Steps 418 through 424 are then performed for each individual transaction that was received in the TPAS transaction request. Particularly, in step 418, the transaction assessment engine 102 checks the security of the transaction to assess whether a transaction is a high risk transaction. Whether a transaction is a high risk transaction is determined based on whether the transaction meets or exceeds one or more of a variety of preset criteria such as, for example, the dollar amount of the transaction, volume of the transaction, frequency of the same type of transaction, or any other desired criteria. These criteria may be established individually by a user for each client, company, or account, or may be predefined for the system 100. Different criteria may also be established for each company, client account, and type of transaction.

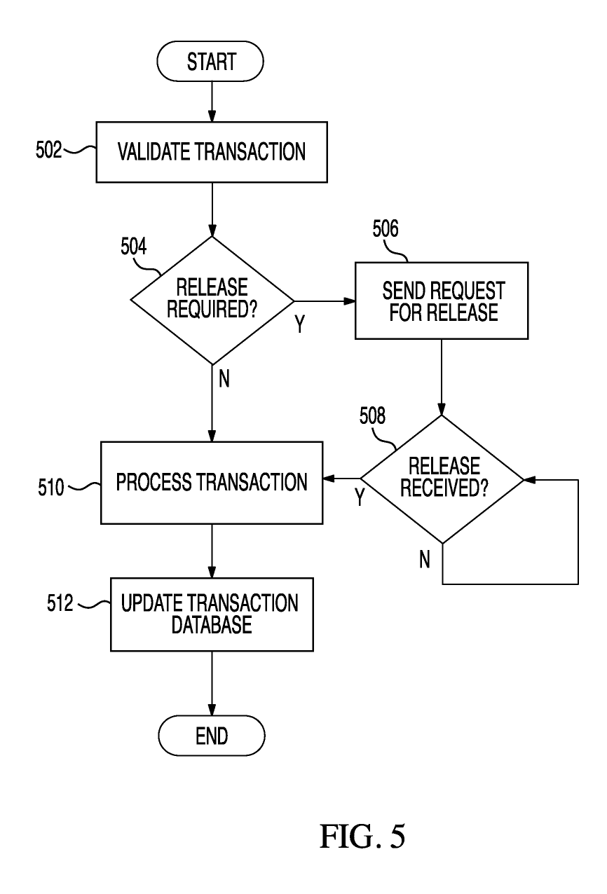

In step 420, the transaction is processed by the transaction processing engine 108. One exemplary method for processing the transaction is illustrated in FIG. 5. In particular, the processing system first validates a transaction in step 502. This may involve, by reference to the entitlements database 104, ensuring that the client, company, and/or account associated with the requested transaction is valid and authorized for the particular type of transaction. This may also involve checking whether all the requisite information to perform the transaction has been provided.

In step 504, the transaction processing engine 108 determines whether a release is required for the requested transaction. In one embodiment, a release is required if a transaction was determined to be a high risk transaction in step 418. If a release is required, a release request message is transmitted to a releaser in step 506. The releaser may be the user that initiated the TPAS transaction request or any other individual that is identified as a releaser in the entitlements database 104 for the relevant client, company, and/or account. As with other types of messages discussed above, the release request message may be communicated to the releaser by transmitting a message to the TPAS, or directly to the releaser using email, voice message, text message, by posting to the bank hosted website, or any other type of communication. In one embodiment, the system 100 may also be configured to transmit an escalated release request message to additional releasers if the prior release request message was not responded to within a predetermined amount of time.

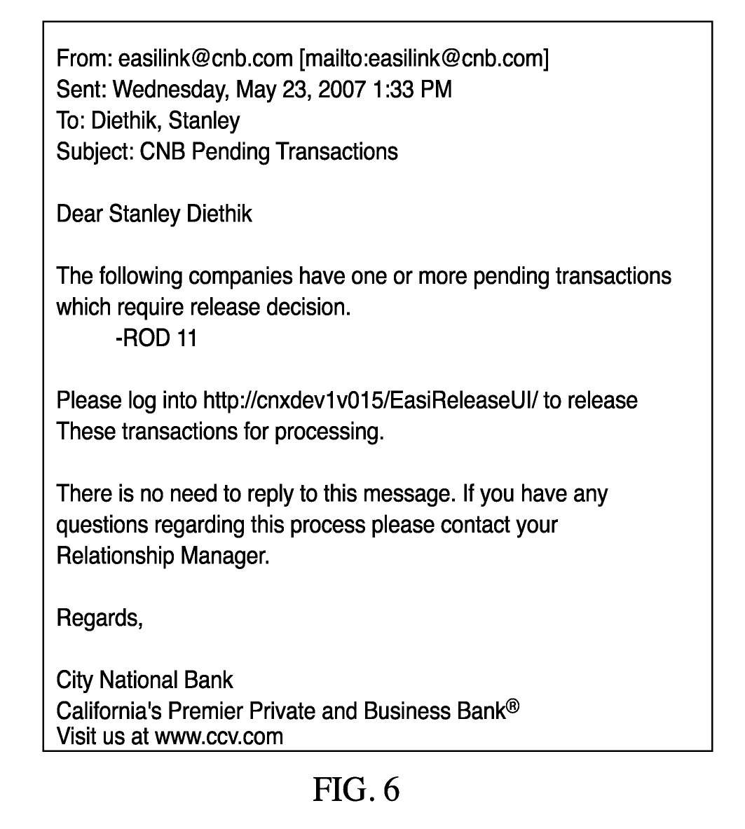

One example of a release request message in accordance with the present invention is illustrated in FIG. 6. In this example the release request message is in the form of an email that is sent directly to a releaser. As can be seen, the email includes directions requesting the releaser to log in to a particular website address in order to authorize release of the particular transaction.

Returning to FIG. 5, once the release request message has been communicated, the transaction processing engine 108 waits for the release to be provided by the releaser in step 508 and proceeds to step 510 upon receiving the release. If no release is required, the process proceeds directly from step 504 to step 510.

In step 510, the transaction is processed in accordance with the parameters of the particular transaction. The transaction database 106 is then updated to reflect the status (i.e., processed, delayed, failed, etc.) of the requested transaction in step 512. It should of course be understood that a transaction need not be processed immediately upon being received by the system 100 or even upon confirmation of a release request. Instead, certain types of transactions, such as ACH transaction, may be processed as batches, at certain times of the day, or at specific intervals.

Referring back to FIG. 4, after the transaction is processed, the process proceeds to step 422. In this step, if the transaction request was interactive, a status message is transmitted to the TPAS, preferably in real time, to indicate the status of the transaction (i.e., that the transaction has been processed, delayed, or could not be processed). Similar to other messages above, a separate message indicating the status may also be transmitted to a user or any other permitted individual, using any type of communication method. In step 424, the system 100 determines whether there are any more transactions to be processed, and if there are, the process returns to step 418.

Although not illustrated in FIG. 4, status messages for non-interactive requests may be provided upon completion of all transactions in a non-interactive TPAS transaction request (for example, if the TPAS transaction request includes multiple transactions), at periodic intervals, at a preset time, or upon a specific request from a user. For example, the system 100 may maintain a transaction results queue for each site ID, and status messages could be created by the system and placed in the transaction results queue at preset intervals. The TPAS may then be configured to periodically, or at specific times, pull responses from the system 100. In another embodiment, a user may initiate a status inquiry request via the TPAS. The status inquiry may be formatted for specific clients and/or accounts, for certain date ranges, or using any other criteria.

FIGS. 7-42 illustrate examples of web interface screens that may be utilized as a portion of the bank hosted website to facilitate setup and interaction with the system 100 disclosed herein. It will of course be understood that these web interface screens merely provide one embodiment by which to interact with the system 100 and should not be interpreted to limit the present disclosure to any one particular type of web interface screen. Nor is the functionality of the system 100 limited to that provided in the examples below. It should also be understood that while the individual accessing the web interface screens in the examples below is referred to as a user, the web interface screens may be utilized by a user, an administrator, or any other individual with access.

FIG. 7 is an example of a home page screen 700 that may be provided as an initial screen visible to a user upon logging into the bank hosted website 110 of the system 100. The home page screen 700 includes a search field 702 that permits a search for an existing company, client, account, or user. The user may also search for a company using an alphanumeric search feature 704 or, if the user has been granted such permission, add a new company to the entitlements database by clicking on the “Add a New Company” link 706, which will take the user to a company details screen 900 for entering details of the new company.

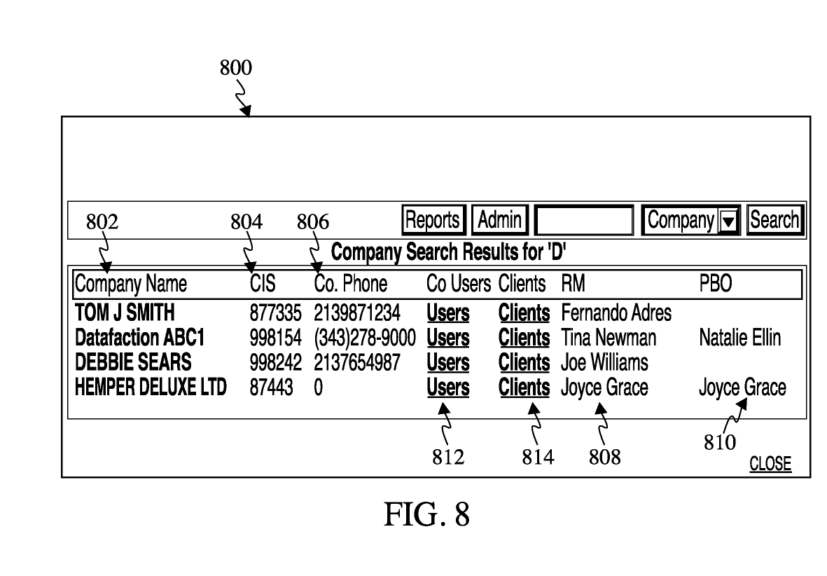

FIG. 8 is an example of a search results screen 800 showing the results of a company search. In the example shown, the results are from a sample company search on the letter “D” from the home page screen 700. As can be seen, for each company that meets the criteria for the search, information is provided regarding the company name 802, the client number 804 (also referred to herein as “CIS”), the company phone 806, the relationship manager (RM) 808, and the personal banking officer (PBO) 810. By selecting the company name, a company details screen 900 for that company may be accessed, where the details for that company can be viewed or updated. All the users or clients associated with a company may also be viewed by selecting the “user” link 812 or “client” link 814, respectively.

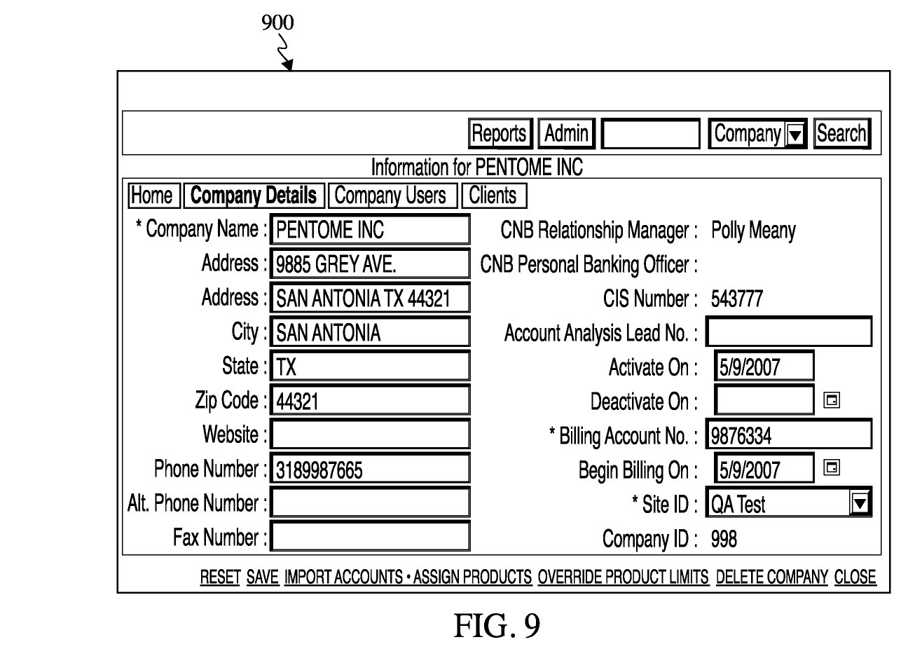

FIG. 9 is an example of a company details screen 900. On this company details screen 900, new information for a company may be added and preexisting company information may be updated. As can be seen, the types of information that may be provided for a company include the company name, company address, company website, company phone numbers, company fax number, account analysis lead number, a date on which the account is to be activated (which may be a current date or a future date), a date on which the account is to be deactivated (if applicable), a billing account number, a date on which billing is to begin, a site ID for the TPAS being utilized to maintain the records for this company, a company ID (which may be automatically assigned by the system), and the names of the relationship manager and the personal banking officer for the company.

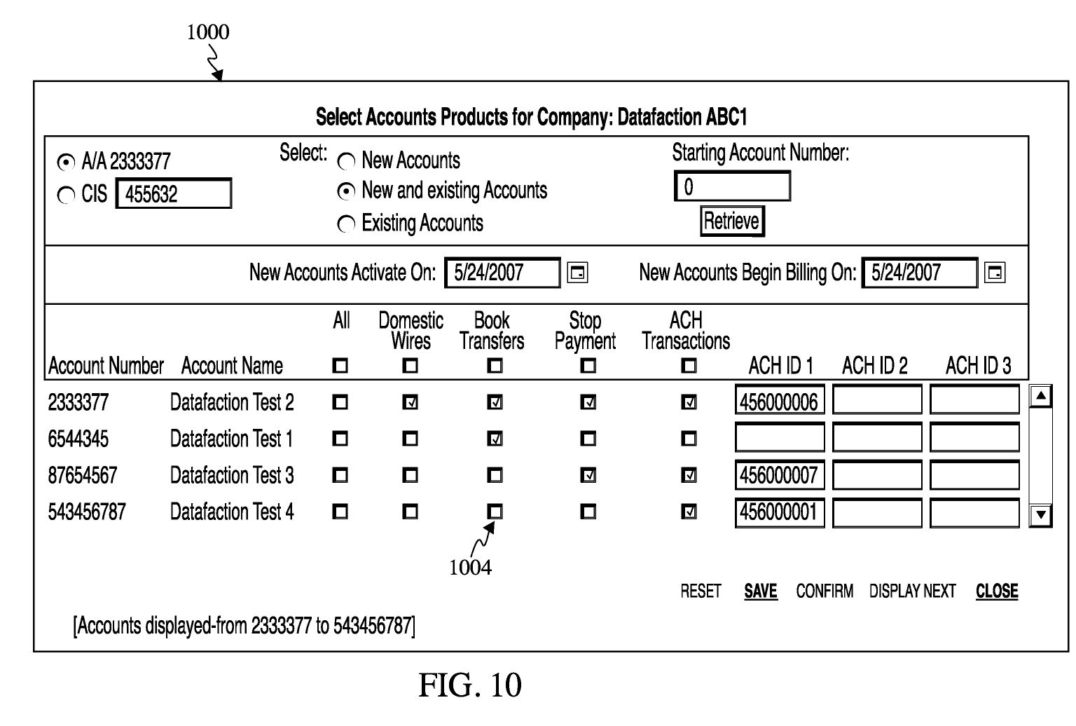

FIG. 10 is an example of an accounts products screen 1000 that permits viewing or adding accounts or a new or existing company, and select products (i.e., types of transactions) that are to be available for each new or existing account. In this embodiment, the accounts products screen 1000 provides radio buttons 1002 that allow a user to choose whether to view all New Accounts, view New and Existing Accounts, or view all Existing Accounts. The accounts may also be sorted by account number, account activation date, or beginning billing date. For each account, the products that are to be available for the account may be selected using selection boxes 1004. In this embodiment, the selectable products include domestic wire transfers, book transfers, stop payments and ACH transactions. This accounts products screen 1000 also permits a user to input up to three ACH IDs for an account.

FIG. 11 is an example of a company users summary screen 1100 that identifies the users 1102 for a given company. For each user, information is provided regarding the user's name, title, email address, and role. In one embodiment, the available roles may include a primary releaser, a secondary releaser, email only, or no role (i.e., information only). In this example embodiment, the primary releaser may be the individual assigned to respond to the all or a majority of release request messages, while the secondary releaser may be assigned to respond only to a specific types of release request messages such as escalated release request messages. An individual with the role of “email only” may be provided with copies of messages but may not have the authority to respond to such messages. New users for a company may be added by selecting the “Add a new company user” link 1104.

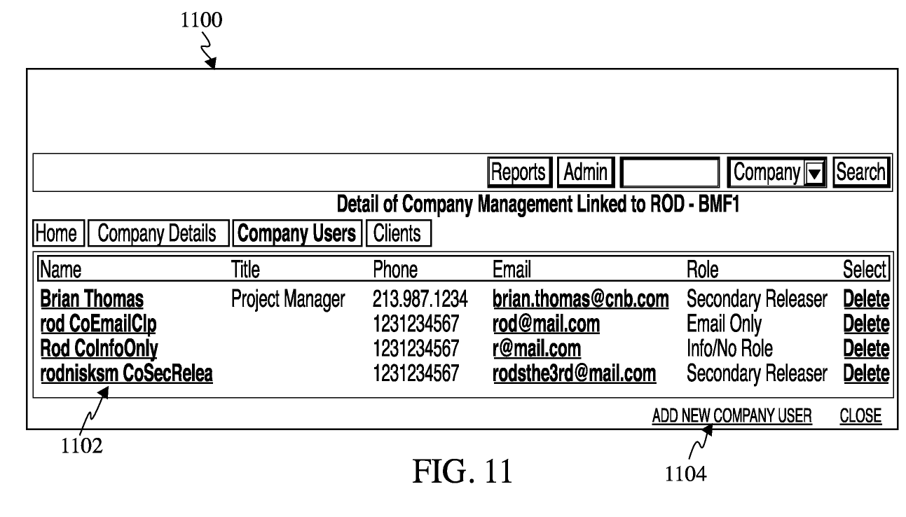

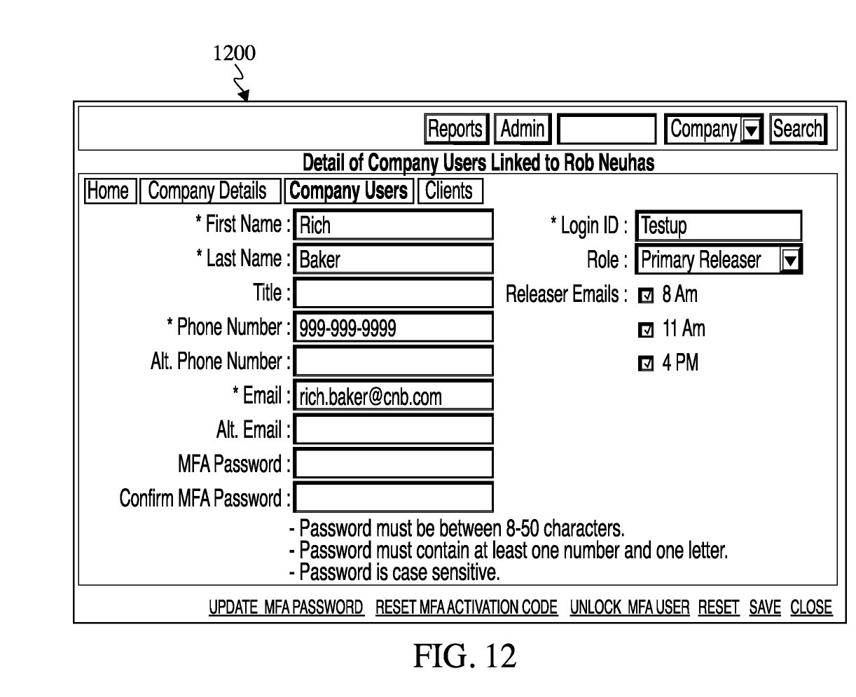

FIG. 12 is an example of a company user details screen 1200 that allows for editing or adding user information. Thus, on this screen, the name, title, email address, and role information for a new or existing user can be provided or edited. This screen also permits a system login password to be set for the user.

FIG. 13 is an example of a company overrides screen 1300 that allows a criteria to be set for determining when a transaction is high risk and thus requires a release. In one embodiment, a number of preset values may be initially provided in the system to determine when a release is required for each specific type of product. In the company override screen 1300, these preset values can be overridden with any other set of limits. As shown, this may include the dollar amount for each transaction, the aggregate limit, or the frequency of the transaction. The number of releasers that must provide a release before a high risk transaction is processed may also be specified. Setting this value to 0 essentially indicates that no release is required for that particular product.

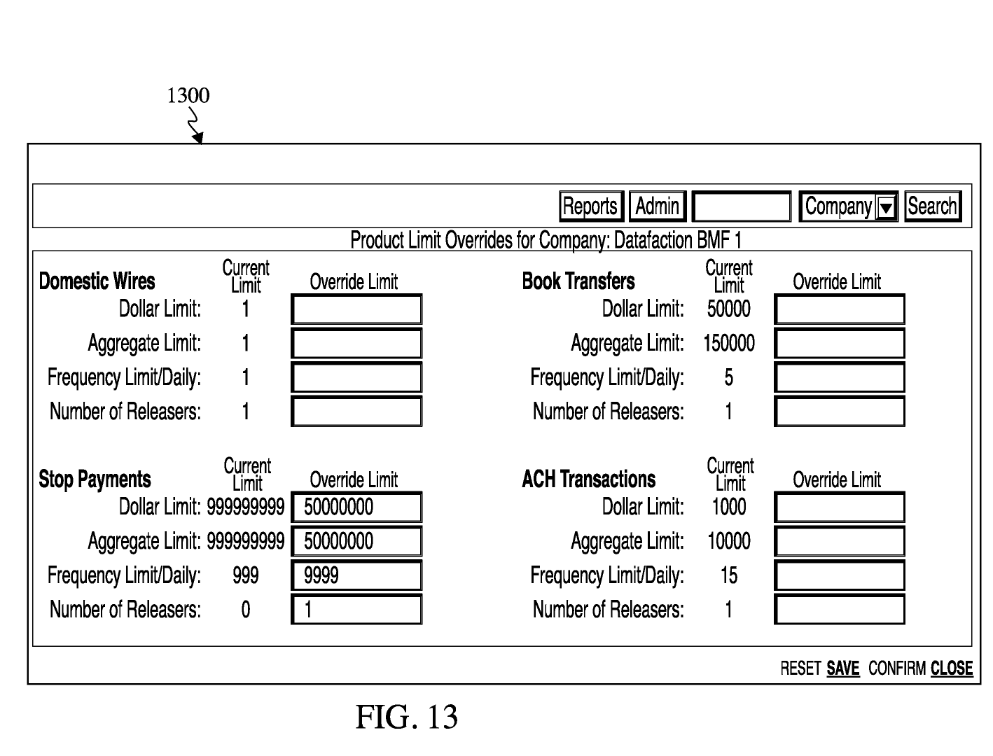

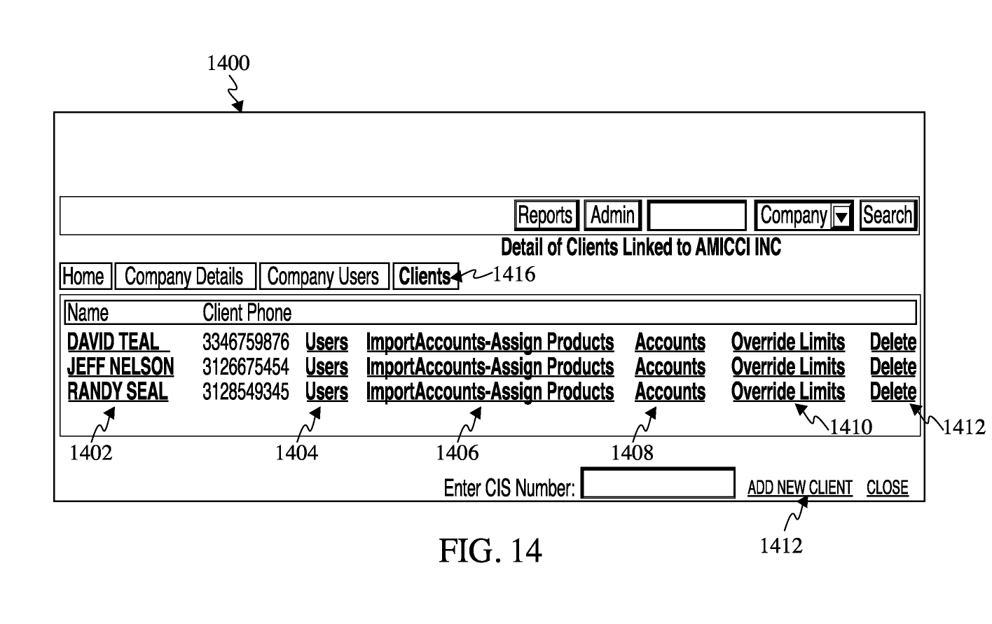

FIG. 14 is an example of a linked clients screen 1400 that reflects a summary of clients associated to a particular company. In one embodiment, this screen may be accessed by selecting the “Clients” tab 1416. By selecting the link associated with a client name on this screen 1402, a client details screen 1500 may be accessed to view or edit the information for a particular client. Selecting the “users” link 1404 accesses the list of users for the client, selecting the “import accounts” link 1406 accesses the list of accounts for the client, selecting the “accounts” link 1408 accesses an account details screen 2000, and selecting the “override limits” link 1410 will access a client overrides screen 1800. A user may also choose to add a new client by selecting the “Add a new client” link 1412, or delete a user by selecting the “Delete” link 1414.

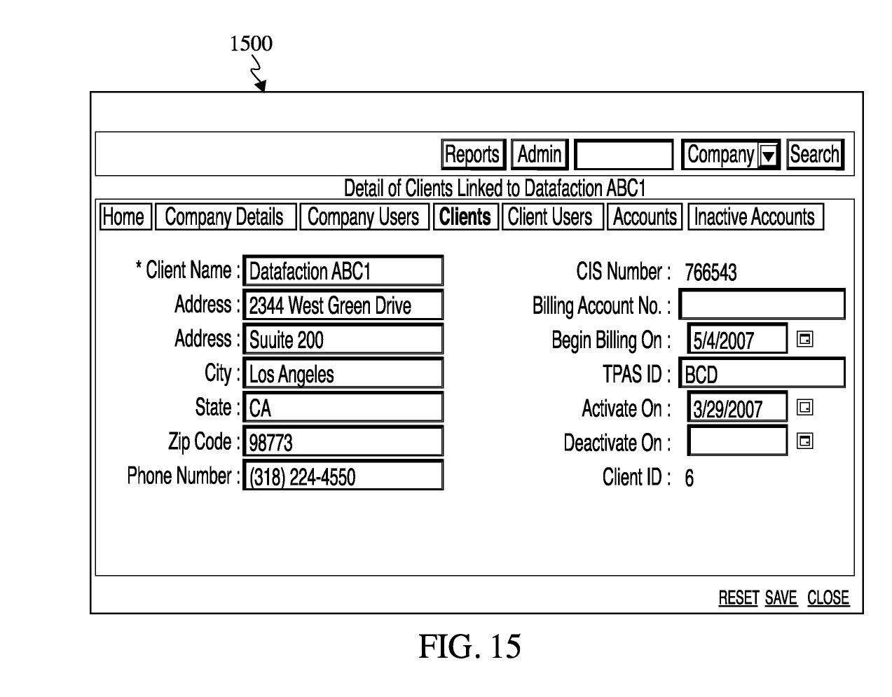

FIG. 15 is an example of a client details screen 1500 that is used to view, edit, or input details for a client. As shown, the information provided for each client may include the client name, address, phone number, CIS number, client ID, TPAS ID, billing account number, the date on which billing is to begin, the date on which the client becomes active, and the date on which the client becomes deactivated.

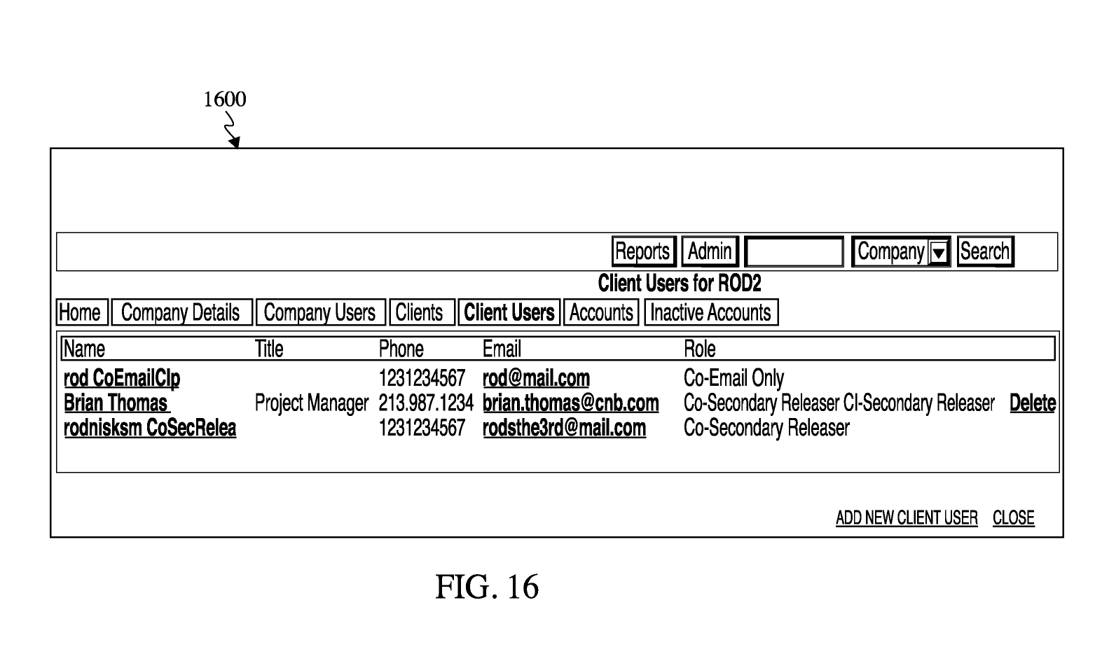

FIG. 16 is an example of a client user screen 1600 that identifies both company level and client level users. This screen provide the name, title, phone number, email address, and role information for each user. Whether a user is company level or client level may also be indicated in the role column. For example, in the illustrated example, a company level user role is indicated with the letters “Co” in the role description where a client level user role is be indicated by the letters “Cl.”

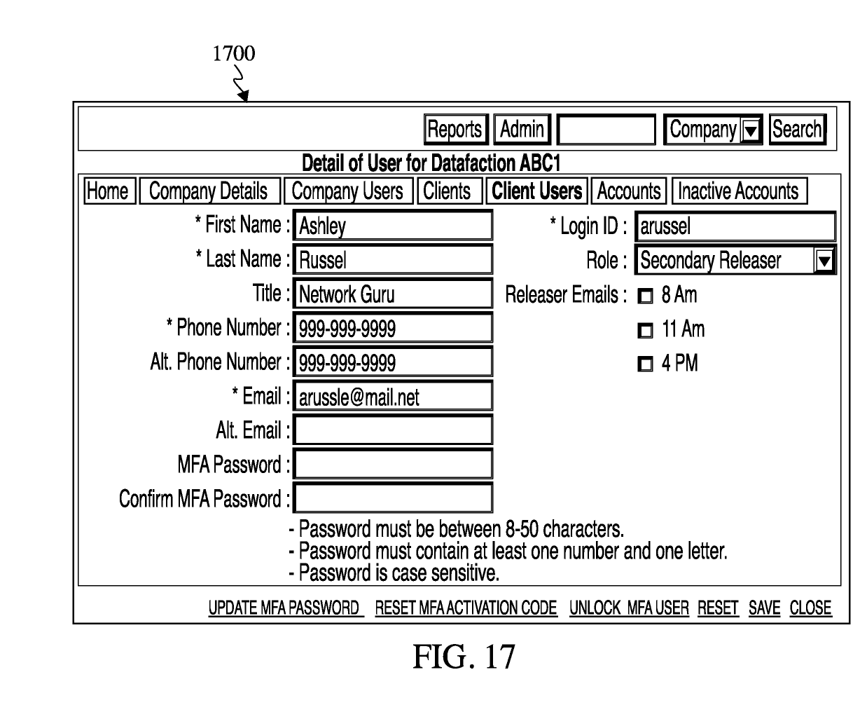

FIG. 17 is an example of a client user details screen 1700 that may be used to update or input client user information. The information that may be provided for a client user includes the name, title, phone number, email address, login ID, password, and the client user role. If the identified user is a releaser, a selection may also be made indicating the time when releaser messages are to be transmitted to that user.

FIG. 18 is an example of a client overrides screen 1800 that allows limits to be set for a particular client to determine when transactions are high risk and require a release. As with the company overrides screen 1300, limits may be set for the dollar amount for each transaction, the aggregate limit, or the frequency of the transaction. The number of releasers that must provide a release before a high risk transaction is processed may also be specified. The client limits may be above or below those values for the related company.

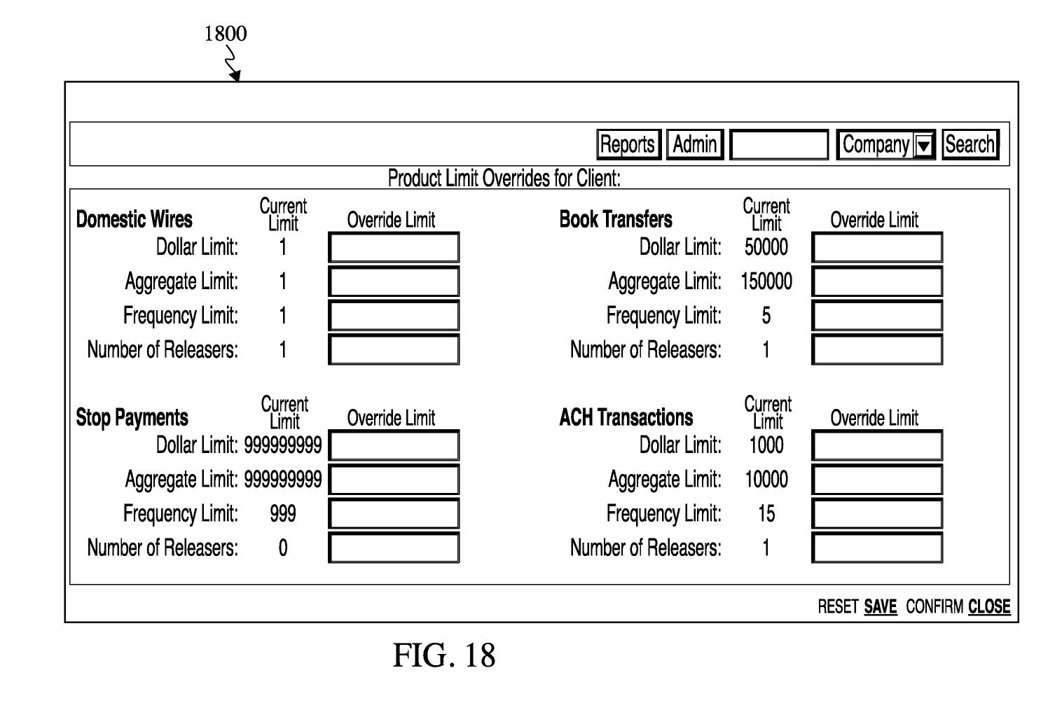

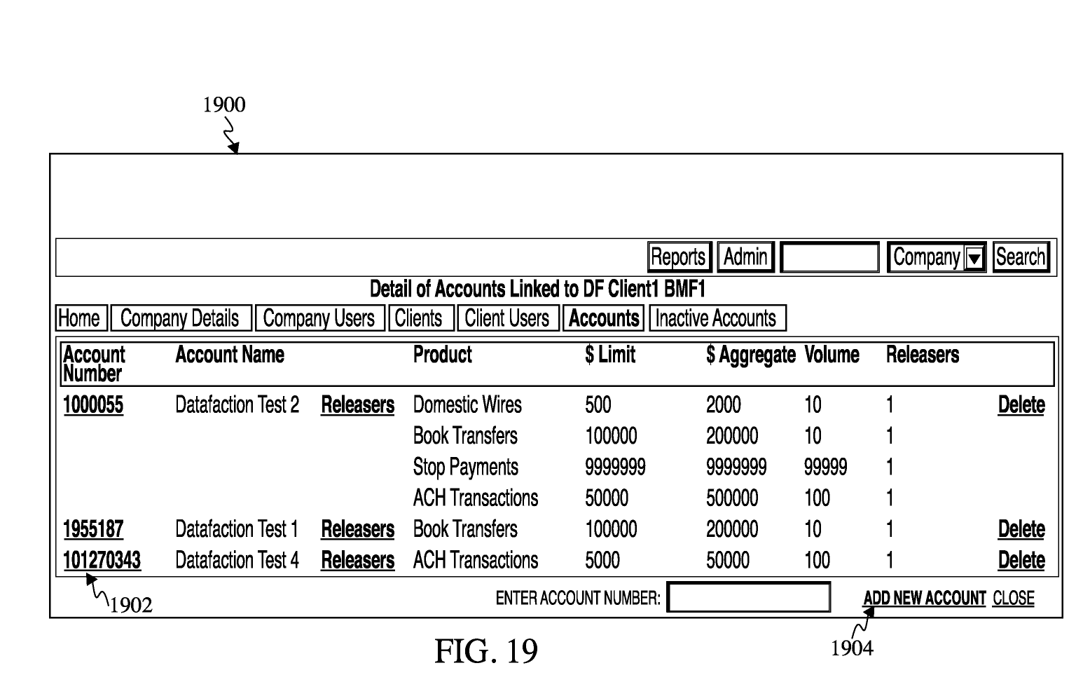

FIG. 19 is an example of an accounts screen 1900 that shows information regarding the accounts associated with a particular client. For each account, the account number, account name, available products, and the set product release limits may be displayed. Account information for a particular account may be edited by selecting the account number 1902 associated with the account. A new account may also be input by selecting the “Add new account” link 1904.

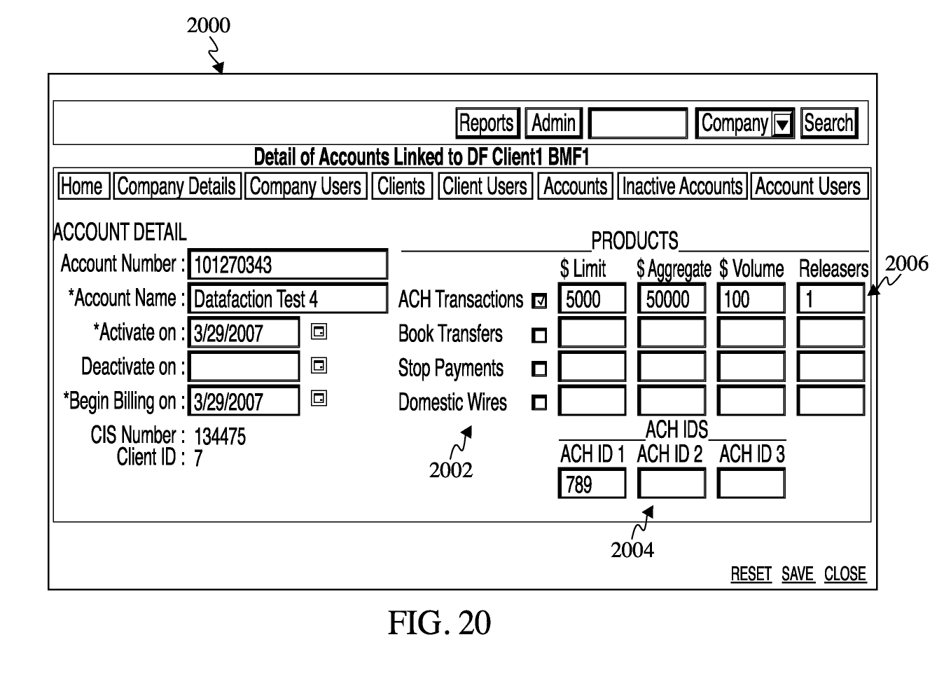

FIG. 20 is an example of an account details screen 2000 that may be used to update existing account information or add a new account to the entitlements database. The account information that may be provided includes the account number, the account name, the date on which the account becomes active, the date on which the account is to be deactivated, and the date on which billing for the account should begin. The account details screen 2000 may also provide checkboxes 2002 for selecting the products that are to be available for the account, fields 2004 for entry of ACH ID numbers, and fields 2006 for entering limits that determine when a release is required for the account. The limits for an account may be the same or different as for the client or company.

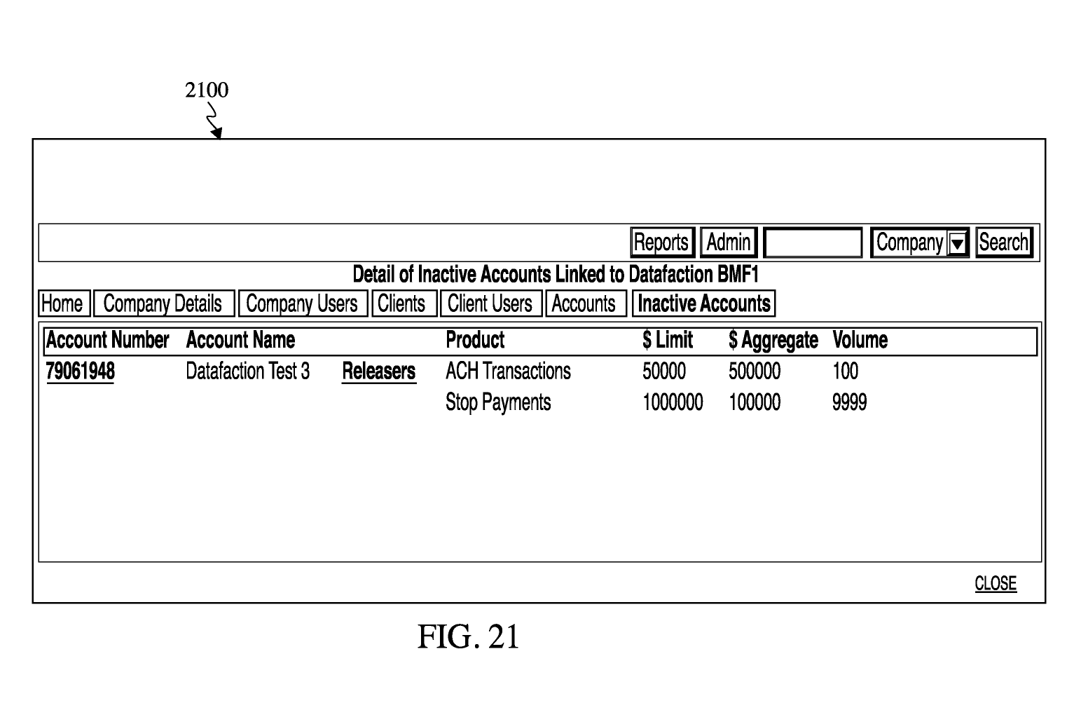

FIG. 21 is an example of an inactive accounts screen 2100 that lists all of the inactive accounts associated with a client within a company. The information fields provided on this screen are preferably the same as the information fields on the account details screen 1900.

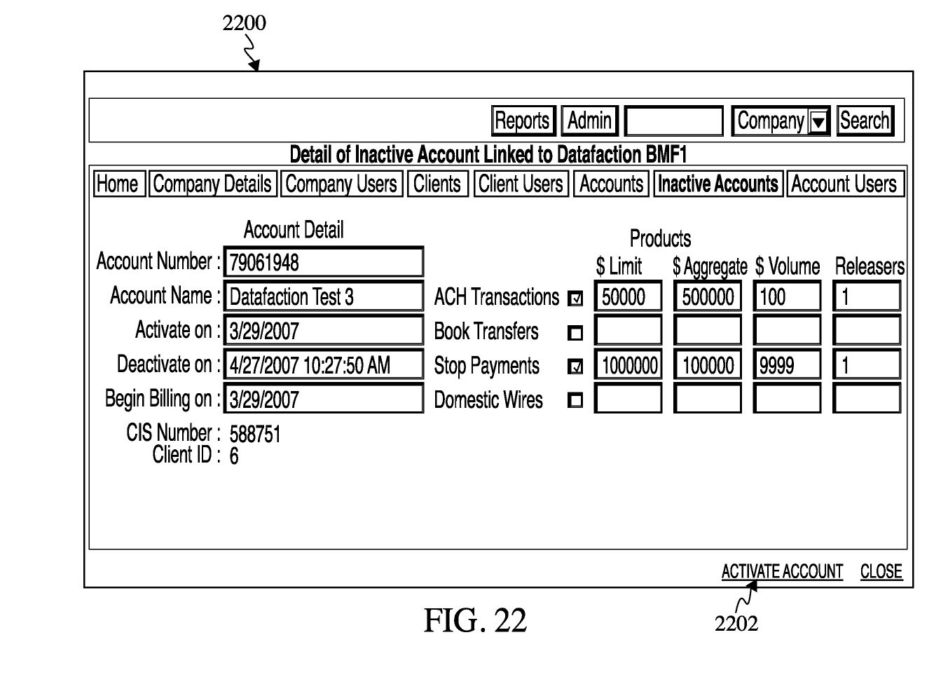

FIG. 22 is an example of an inactive account details screen 2200 that shows detailed information regarding inactive accounts. The provided information is preferably the same as that in the accounts details screen 2000. On this screen 2200, a user may activate an inactive account by selecting the “activate account” link 2202.

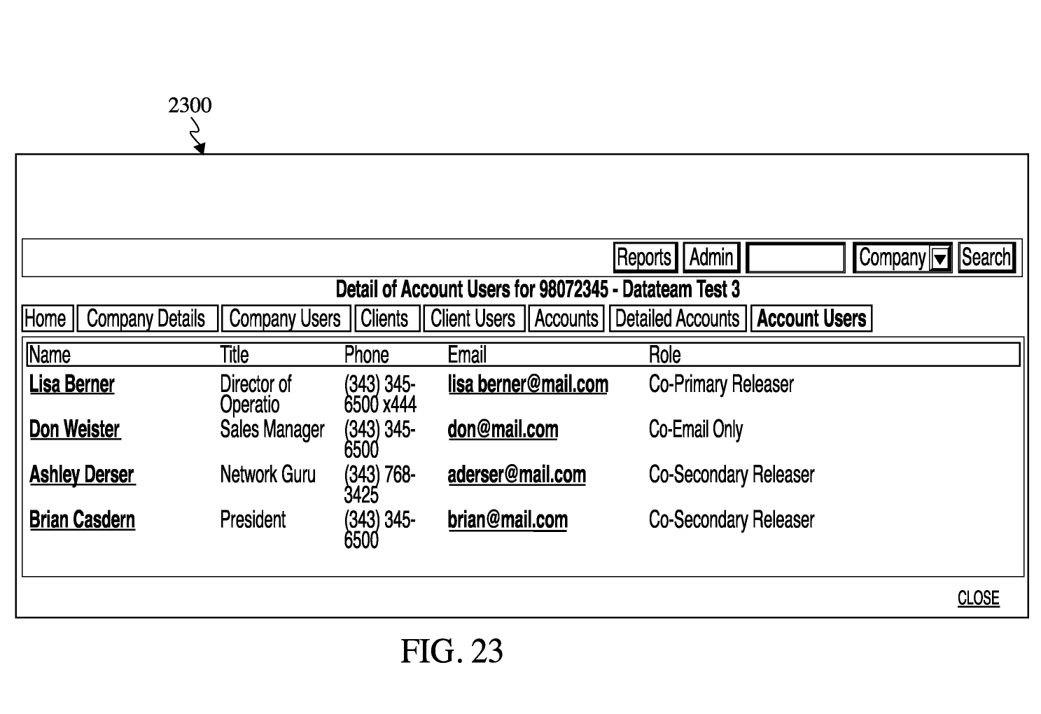

FIG. 23 is an example of an account user summary screen 2300. This screen provides a list of all the users for an account that have a role other than “No Role” with regards to a selected account. For each user, information is provided regarding their name, title, phone number, email address, and role. Selecting an account user name will link to the account user details screen 2400 to allow updating of the information for that account user.

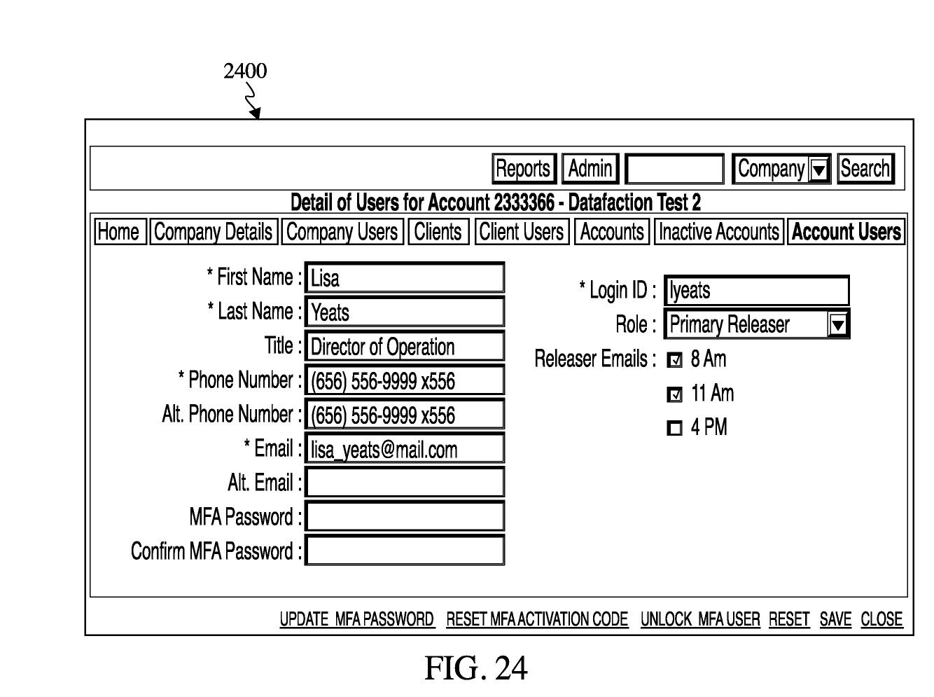

FIG. 24 is an example of an account user details screen 2400 that allows information for an account user to be added or updated. The information that may be input includes the name, title, phone number, alternate phone number, email address, role, and login ID. The user may also be permitted to select times when messages are to be sent requesting a transaction release.

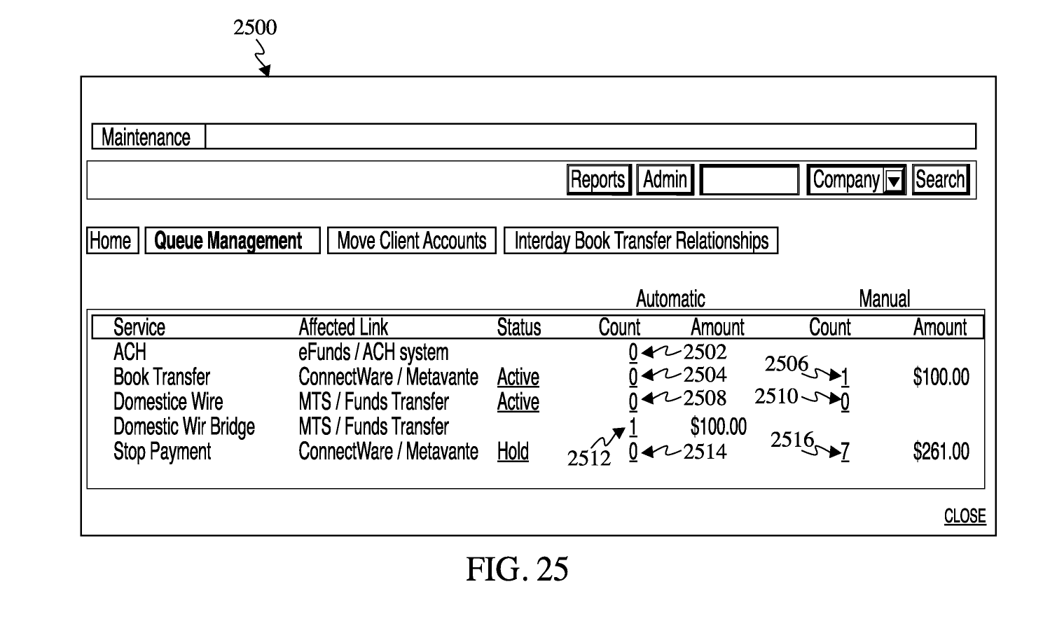

FIGS. 25 through 35 provide examples of website interface screens that may be accessed via selection of the “admin” button on the prior discussed screens. FIG. 25 is an example of a queue management screen 2500 that provides a snapshot of the processing information at a given time. The information provided may include the name of each type of service (i.e., transaction) that is available, the affected processing link (i.e., the particular aspect or aspects of the transaction processing engine 108 that performs the transaction), the status of the respective processing link (which may be, for example, active, down, or on hold), the number of automatic and manual transactions of each transaction type that have been received by the system 100 but not yet sent to the transaction processing engine 108, and the respective dollar amounts for the transactions. By clicking on the status indication for a particular transaction, a user can toggle the status of the processing system. This provides the user when the ability to stop and start transactions of a particular type.

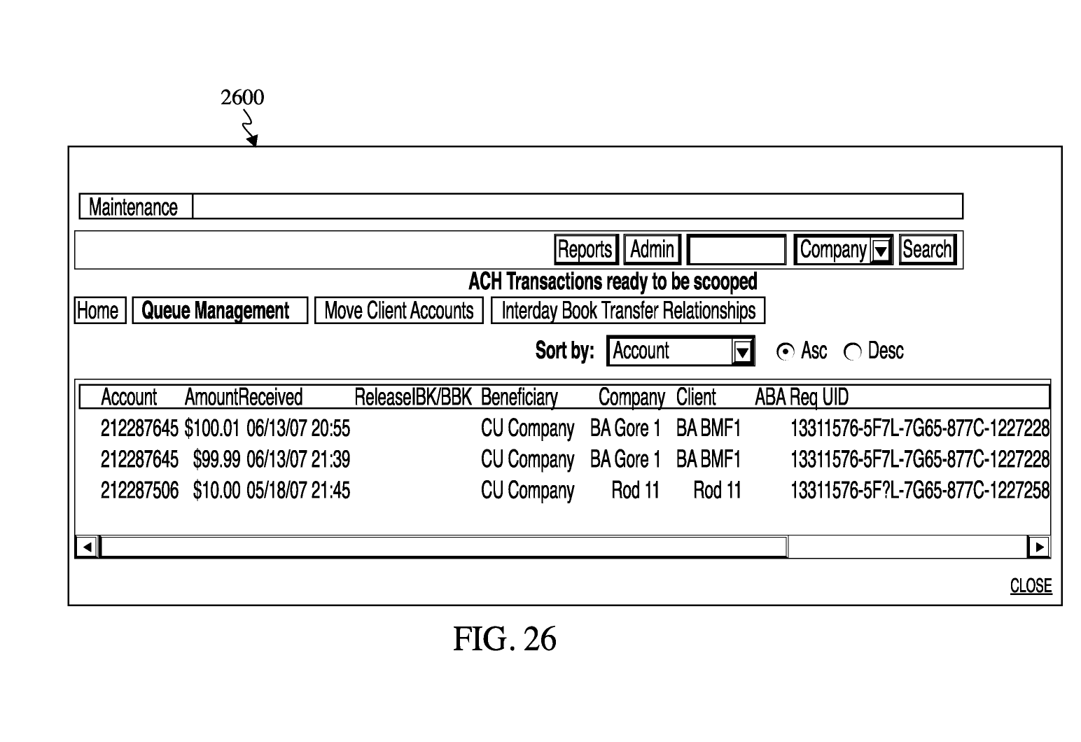

FIG. 26 is an example of an ACH management screen 2600 that may be accessed by selecting the count number 2502 for the ACH transaction type in the queue management screen 2500. The ACH management screen 2600 provides a list of all the ACH transactions that are ready to be sent for processing (which may occur at certain intervals or at preset times). For each ACH transaction, the account number, amount received, beneficiary, company client and batch ID number are provided.

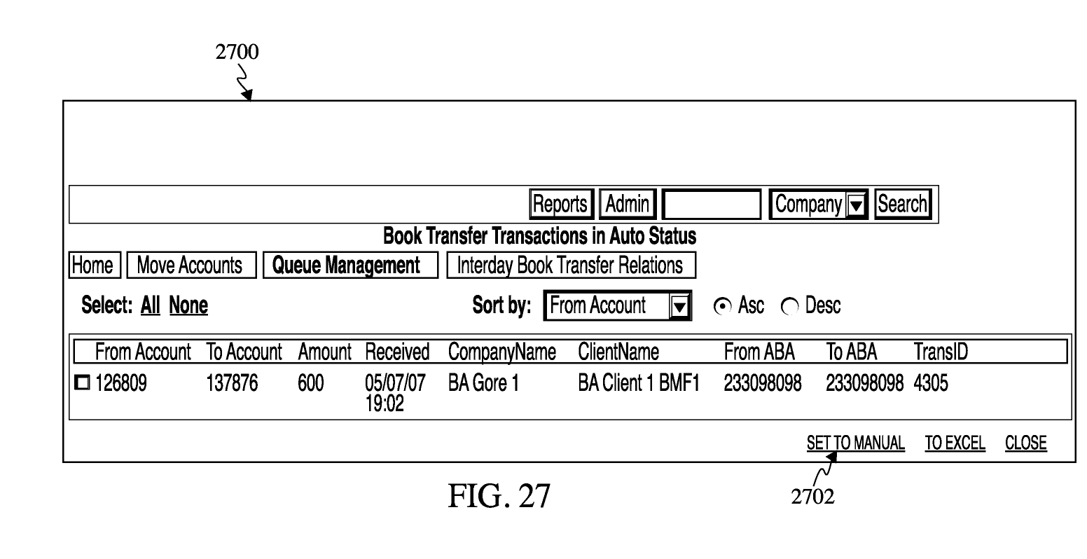

FIG. 27 is an example of an automatic book transfer management screen 2700 that may be accessed by clicking on the count number 2504 under automatic for the book transfer service in the queue management screen 2500. The automatic book transfer management screen 2700 provides a list of the book transfers that have an automatic status and have not yet been sent for processing. For each automatic book transfer, the sending account, receiving account, amount, date and time received, company name, and client name are provided. By selecting the “set to manual” link 2702, the user can also change the status of a selected transaction to manual status.

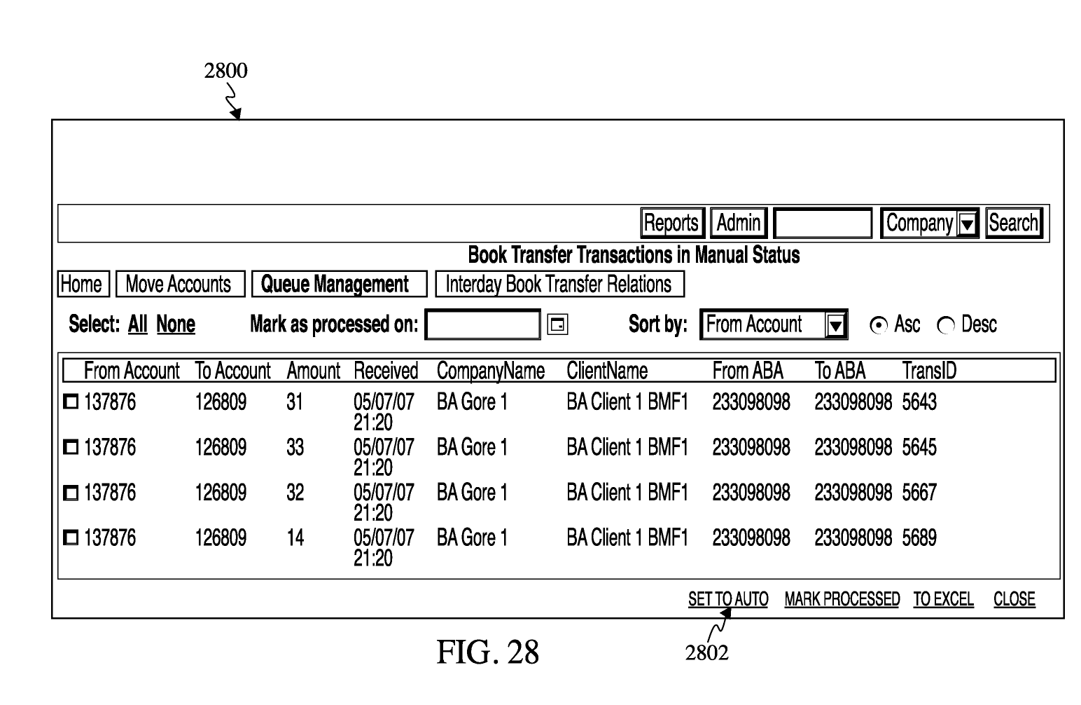

FIG. 28 is an example of a manual book transfer management screen 2800 that may be accessed by clicking on the count number 2506 under manual for the book transfer service in the queue management screen 2500. The manual book transfer management screen 2800 provides a list of the book transfers that have a manual status and have not yet been sent for processing. For each manual book transfer, the sending account, receiving account, amount, date and time received, company name, client name are provided. By selecting the “set to auto” link 2802, the user can also change the status of a selected transaction to automatic status.

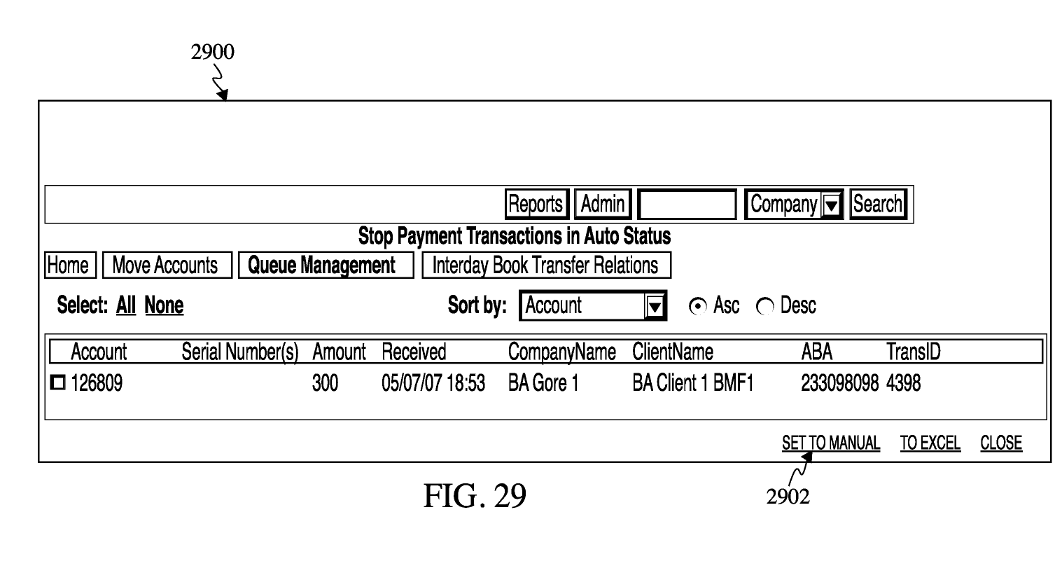

FIG. 29 is an example of an automatic stop payment management screen 2900 that may be accessed by clicking on the count number 2514 under automatic for the stop payment service in the queue management screen 2500. The automatic stop payment management screen 2900 provides a list of the stop payment transactions that have an automatic status and have not yet been sent for processing. For each automatic stop payment, the account serial number, the amount, the date/time received, the company name, and the client name are provided. By selecting the “set to manual” link 2902, the user can also change the status of a selected transaction to manual status.

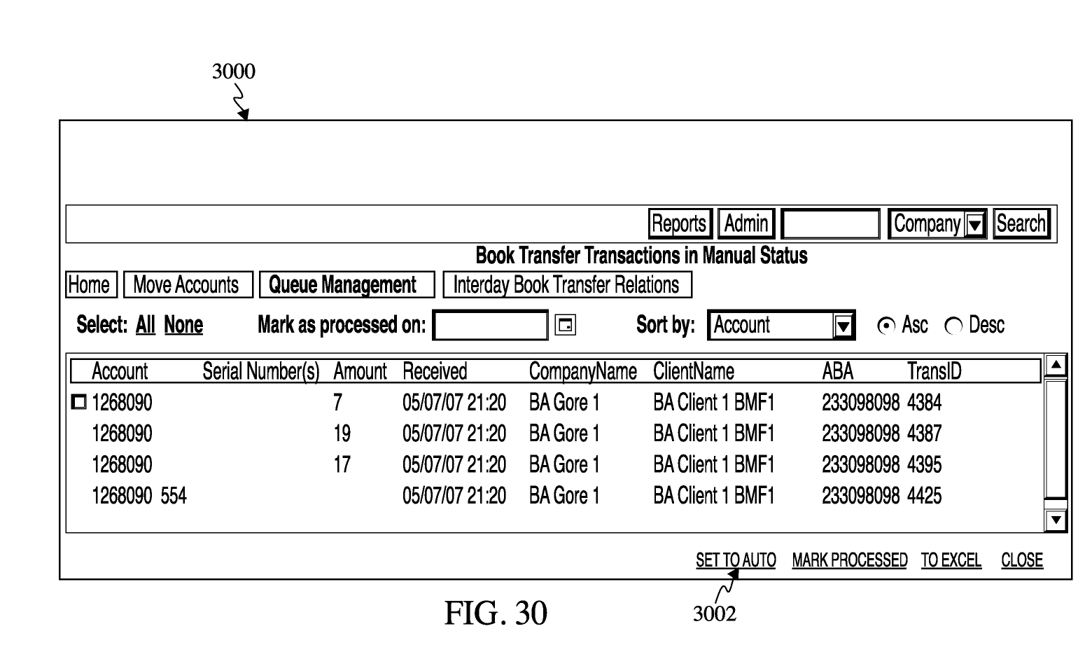

FIG. 30 is an example of a manual stop payment management screen 3000 that may be accessed by clicking on the count number 2516 under manual for the stop payment service in the queue management screen 2500. The manual stop payment management screen 3000 provides a list of the stop payment transactions that have a manual status and have not yet been sent for processing. For each manual stop payment, the account serial number, the amount, the date/time received, the company name, and the client name are provided. By selecting the “set to auto” link 3002, the user can also change the status of a selected transaction to automatic status.

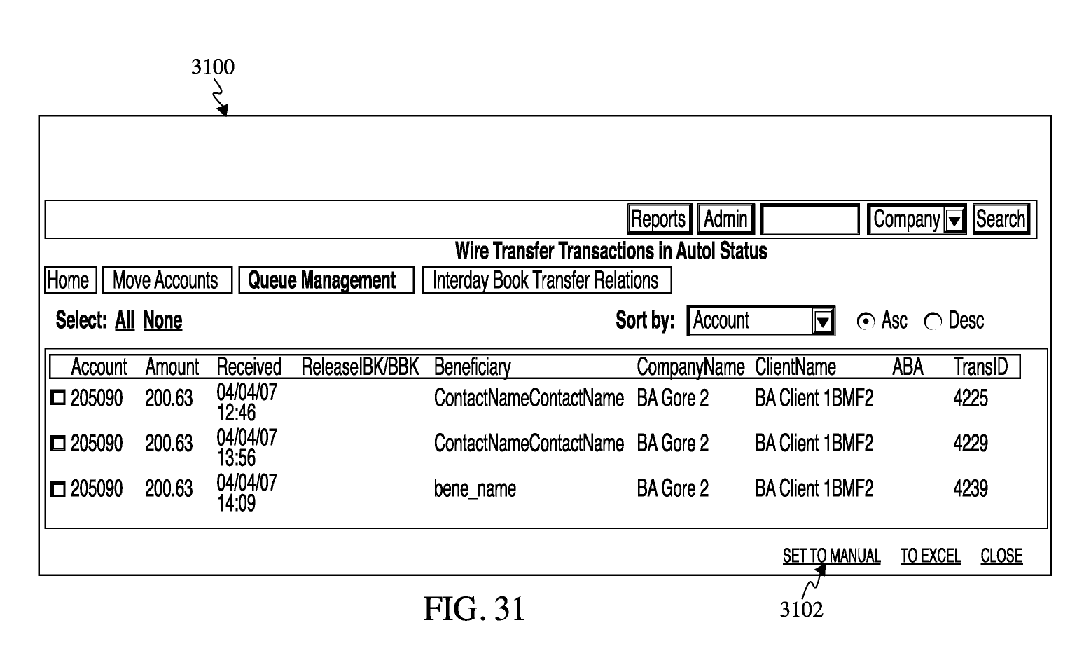

FIG. 31 is an example of an automatic domestic wire transfer management screen 3100 that may be accessed by clicking on the count number 2508 under automatic for the domestic wire transfer service in the queue management screen 2500. The automatic domestic wire transfer management screen 3100 provides a list of the domestic wire transfer transactions that have an automatic status and have not yet been sent for processing. For each automatic domestic wire transfer, the account number, serial number, amount, company name, and client name are provided. By selecting the “set to manual” link 3102, the user can also change the status of a selected transaction to manual status.

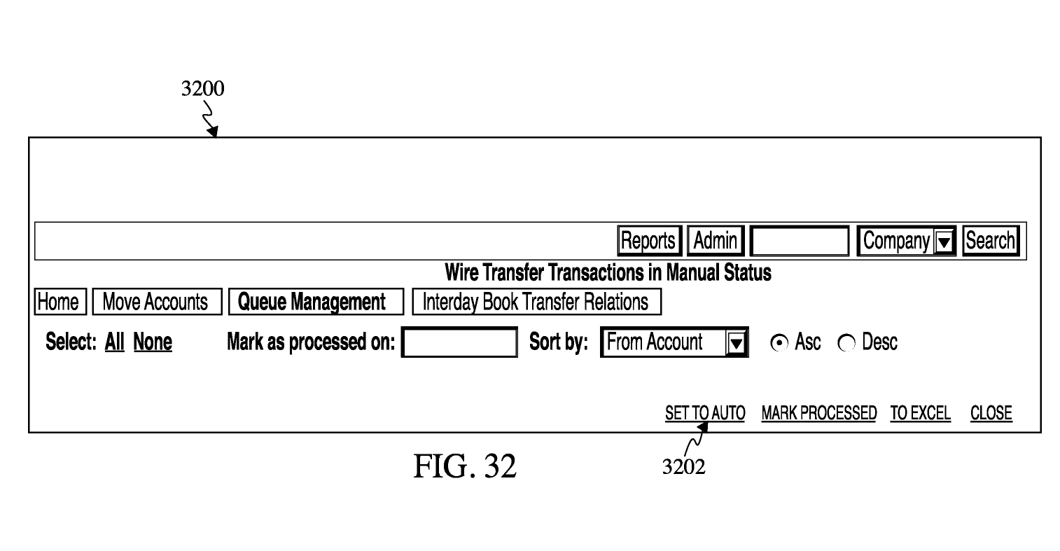

FIG. 32 is an example of a manual domestic wire transfer management screen 3200 that may be accessed by clicking on the count number 2510 under manual for the domestic wire transfer service in the queue management screen 2500. The manual domestic wire transfer management screen 3200 provides a list of the domestic wire transfer transactions that have a manual status and have not yet been sent for processing. For each manual domestic wire transfer, account number, serial number, amount, company name, and client name are provided. By selecting the “set to auto” link 3202, the user can also change the status of a selected transaction to automatic status.

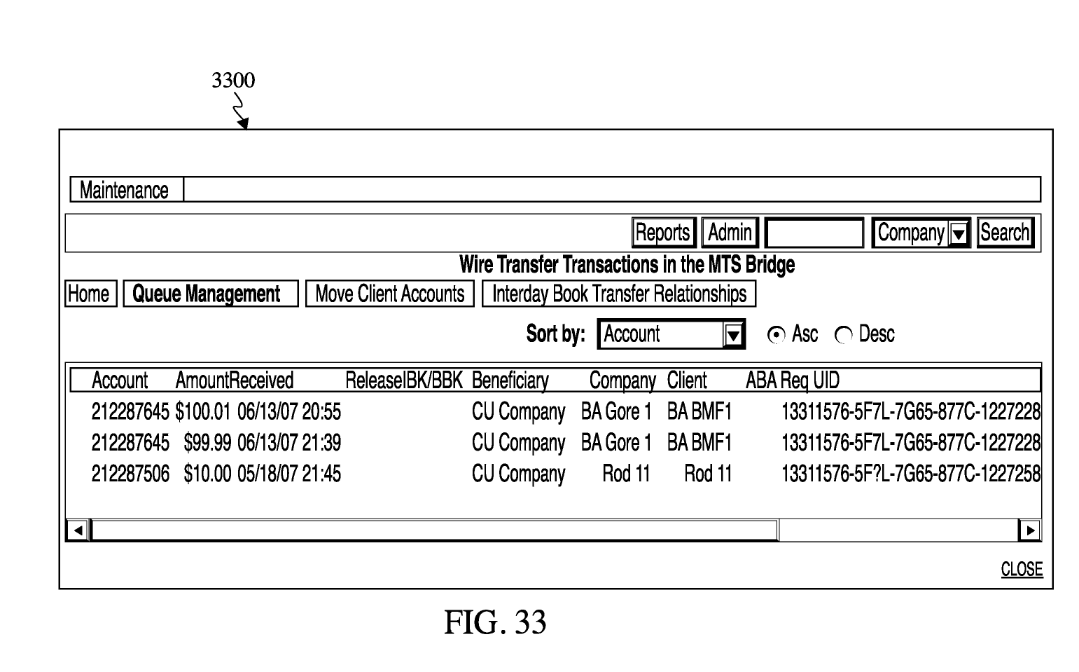

FIG. 33 is an example of a domestic wire bridge management screen 3300 that may be accessed by clicking on the count number 2512 for the domestic wire bridge service in the queue management screen 2500. The domestic wire bridge management screen 3300 provides a list of the domestic wire bridge transactions that have not yet been sent for processing. For each domestic wire bridge transaction, the account number, amount, beneficiary, company client and Request ID are provided.

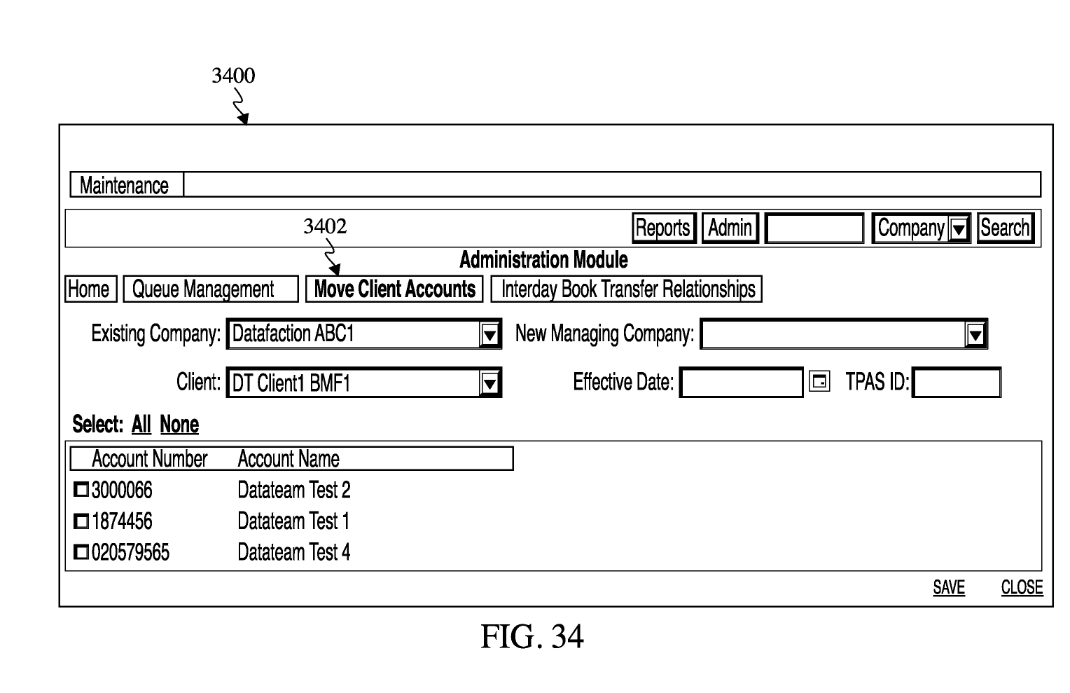

FIG. 34 is an example of a client movement screen 3400 that can be accessed by selecting the “move client accounts” 3402. This screen permits a client to be moved from one company to another. The effective date for the move may also be input.

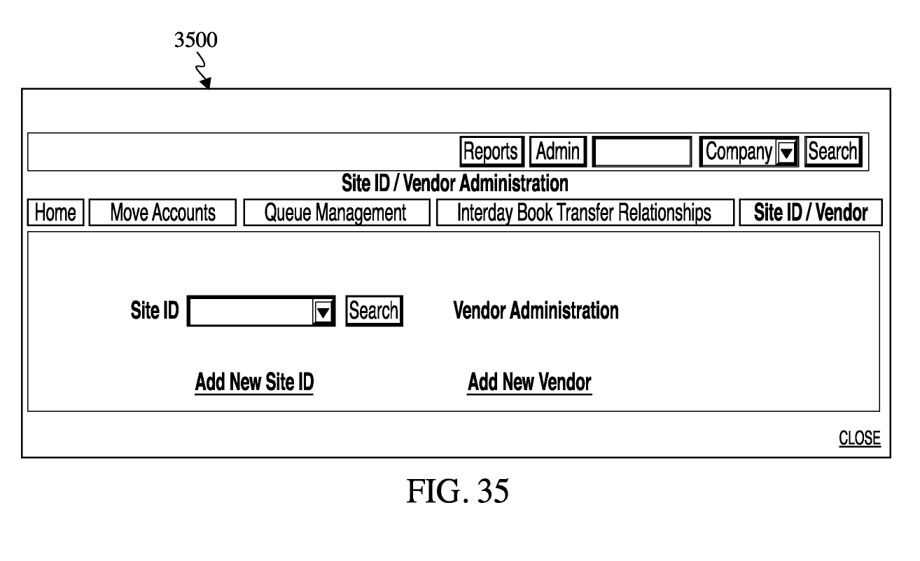

FIG. 35 is an example of a site ID details screen 3500 in which information for a site ID can be edited or added. In this screen, the site ID information may include the site ID name, the IP address, the administrator name, the administrator phone number, the administrator email address, the FTP folder in, and the FTP folder out.

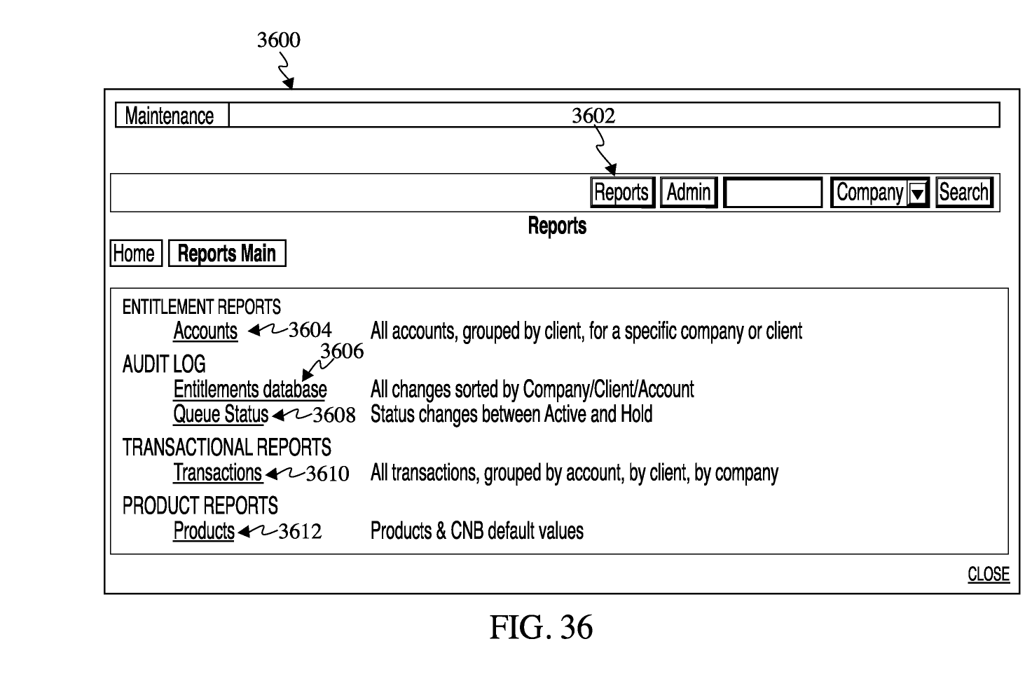

FIGS. 36 through 42 illustrate a plurality of web interface screens that may be used for generating various reports in the system 100. In FIG. 36, an example of a reports intro screen 3600 is shown. The reports intro screen 3600 may be reached by selecting the reports tab 3602. The reports intro screen permits a user to select different report by clicking on the appropriate link within the desired category, such as entitlements reports, audit logs, transactional reports, and product reports.

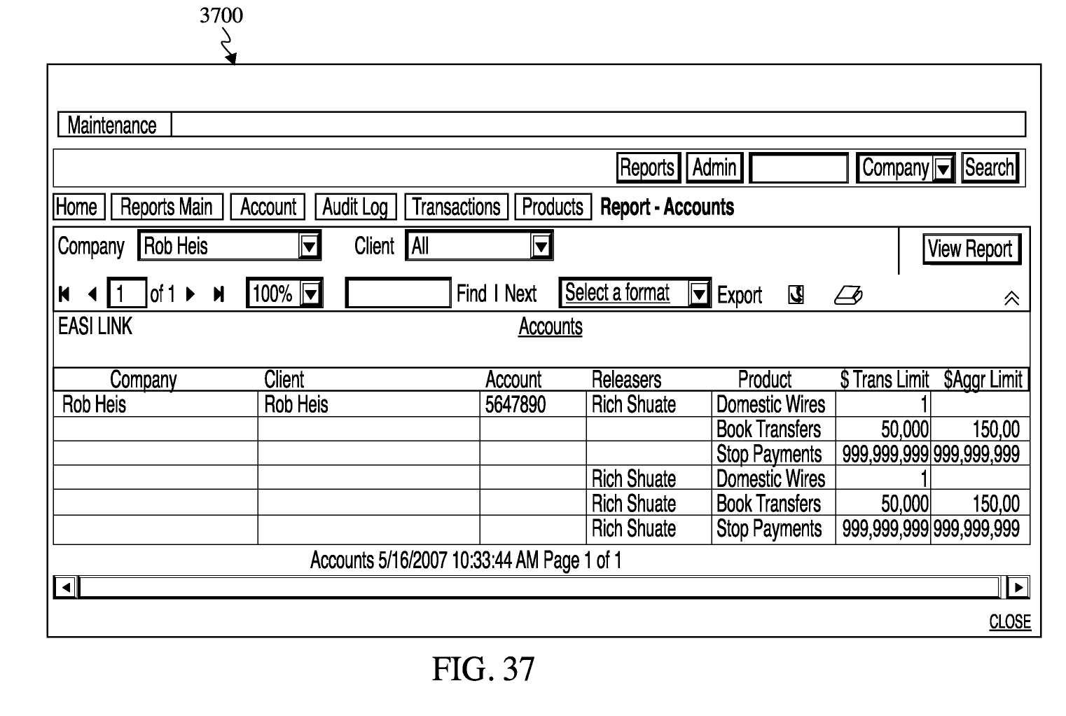

FIG. 37 shows an example of an accounts report screen 3700 that can be reached by selecting the accounts link 3604 under the entitlements reports category in the reports intro screen 3600. The accounts reports screen 3700 provides the user with information identifying the company, client, releasers, products, and release limits for a selected company or client.

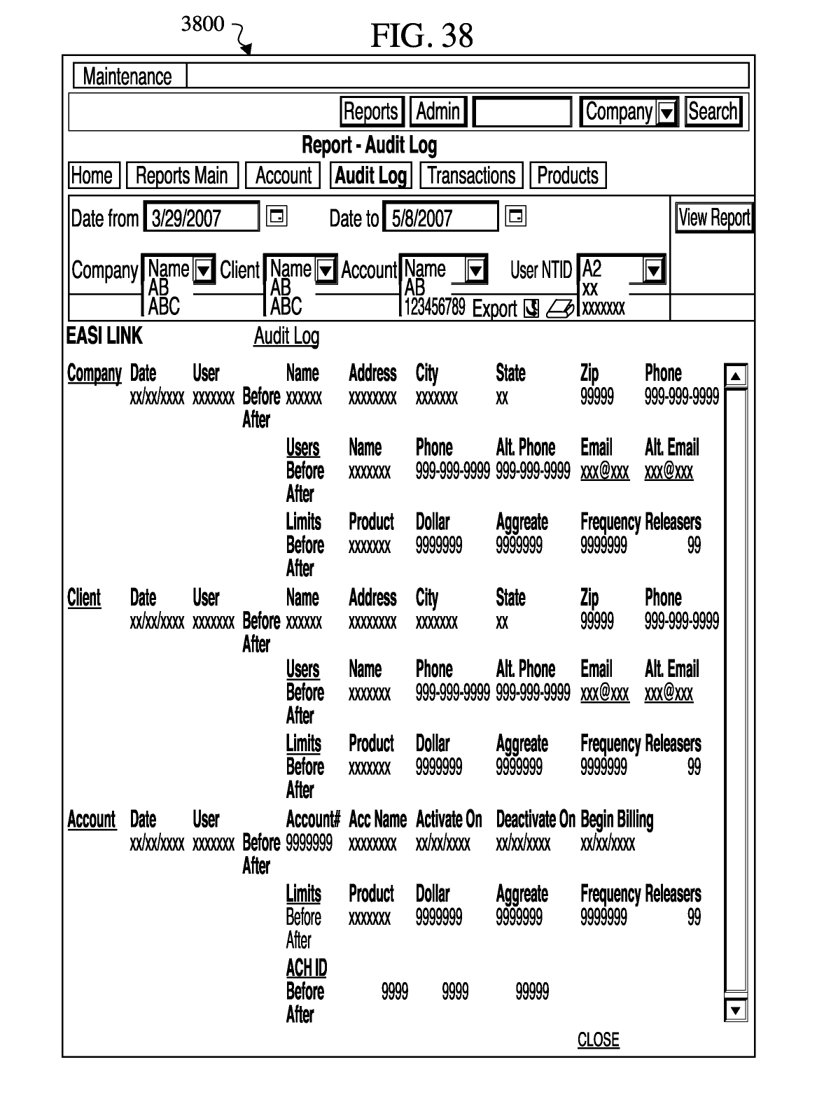

FIG. 38 shows an example of an audit log report screen 3800 that can be reached by selecting the entitlements database link 3606 under the audit log category in the reports intro screen 3600. The audit log report screen 3800 reflects changes made to the entitlements database 104 by various users. The audit log report screen 3800 can be generated based on the company, client, account, or user ID, for any time period.

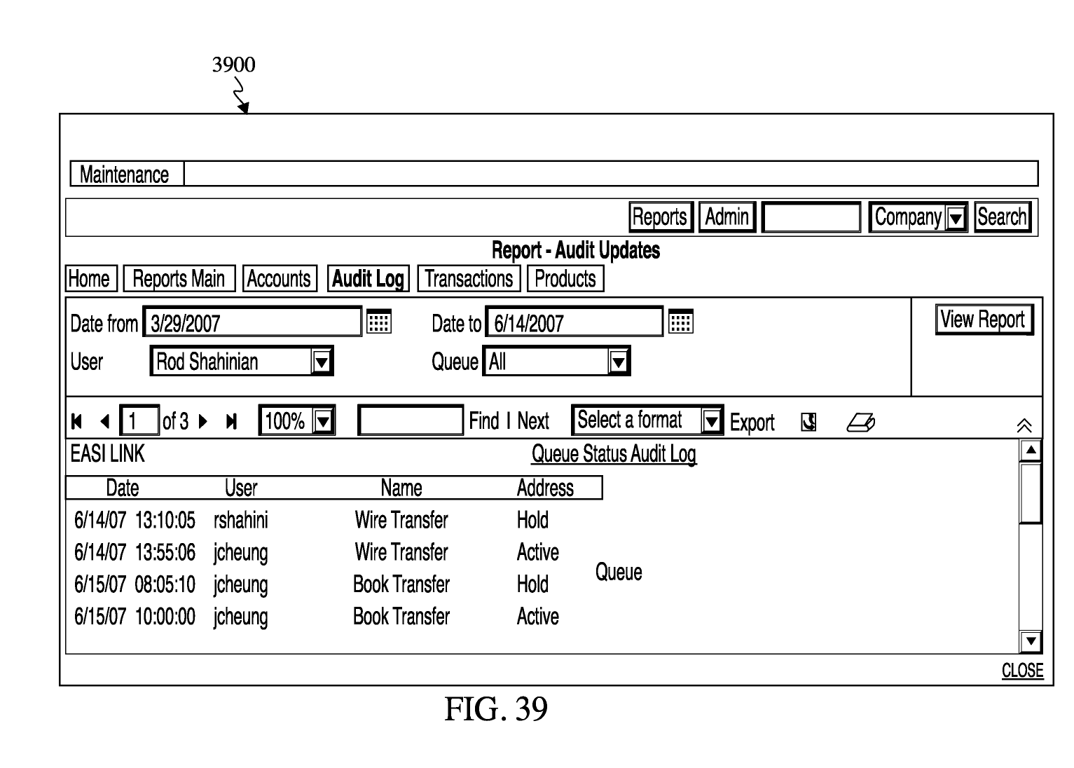

FIG. 39 is an example of a queue status report screen 3900, that can be reached by selecting the queues status link 3608 under the audit log category in the reports intro screen 3600. The queue status reports screen reflects status changes in various process queues from active to hold and back. The queue status report can be generated based on specific queues, date ranges, or by user ID.

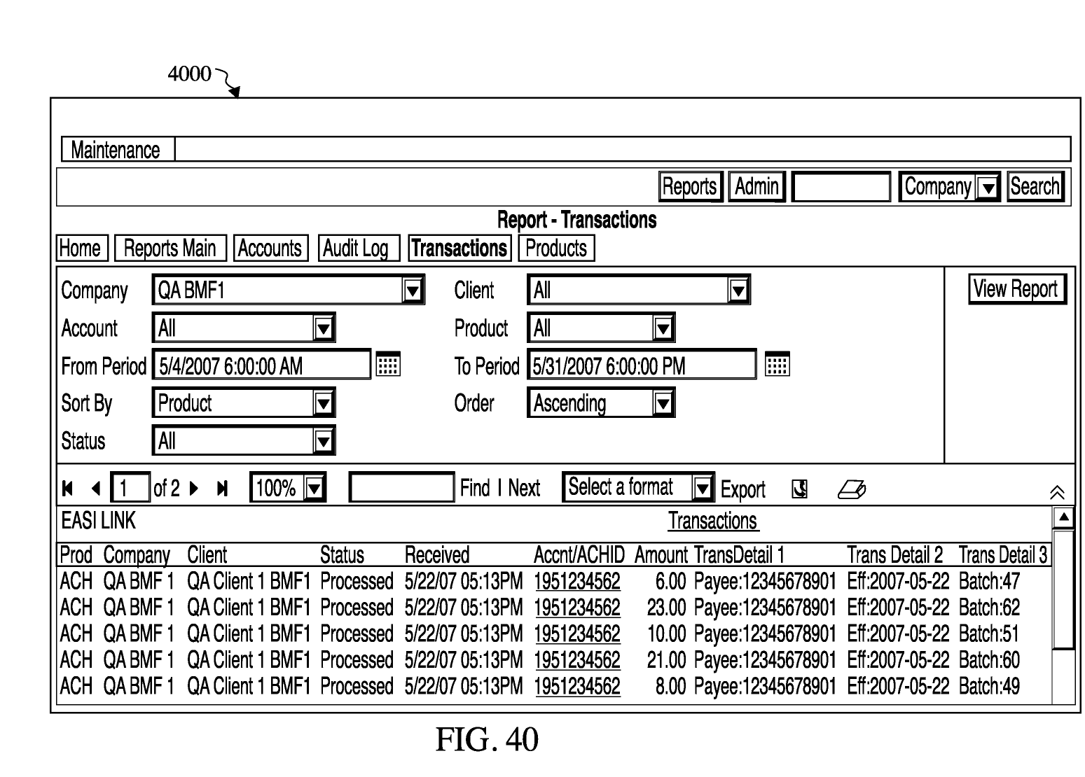

FIG. 40 is an example of a transactions report screen 4000 that can be reached by selecting the transactions link 3610 under the transactional reports category in the reports intro screen 3600. The transactions report screen 4000 may be used to produce a transaction report based on the company, client, product, and/or transaction status. The user may also specify the date range for the report.

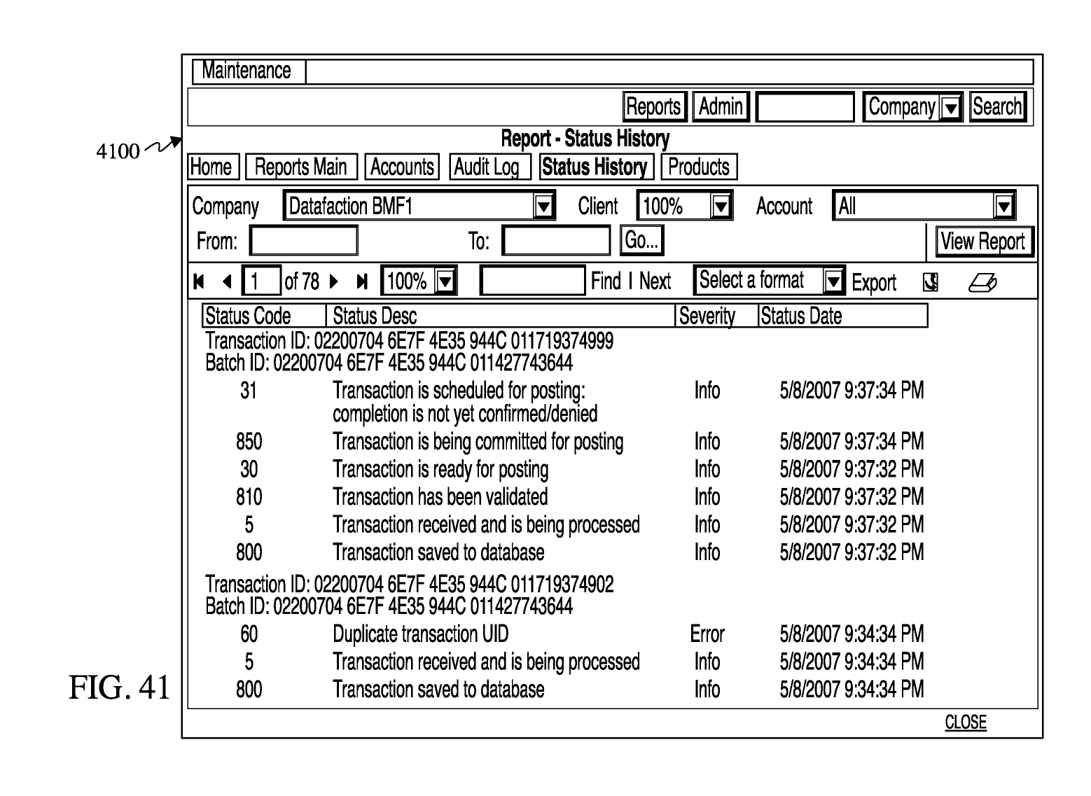

FIG. 41 is an example of a status history report screen. This screen allows a user to generate a status history report of transaction for a selected company, client or account, for a selected time period. The status history report provides information regarding the status code, status description, severity of status, and the status date for each company client or account within the selected time period.

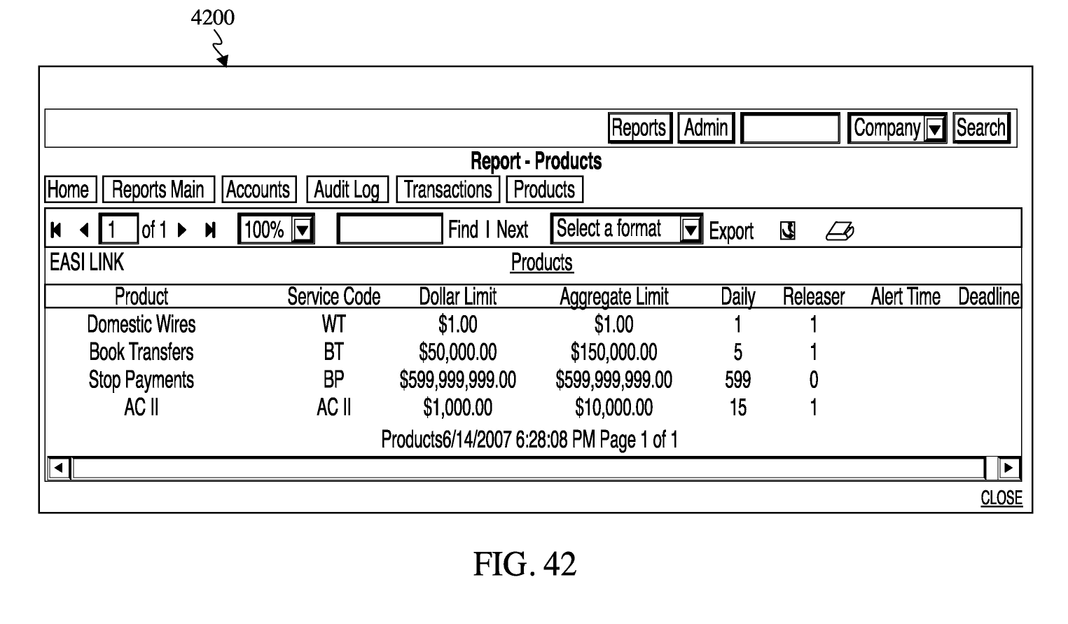

FIG. 42 is an example of a products report screen 4200 that can be reached by selecting the products link 3612 under the product reports category in the reports intro screen 3600. The products report screen 4200 allows a user to generate a products report that reflects a summary of the products, the release limits, alert times, and deadlines for each of the products set up in the entitlements database.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for processing financial transactions, comprising the steps of:
receiving a transaction request from a third party accounting software, the transaction request including one or more transactions;
verifying, based on information stored in a first database, that the transaction request is from a valid source;
storing information regarding the one or more transactions from the transaction request in a second database;
processing the one or more transactions; and
providing a response to the third party accounting software indicating a status of at least one transaction in the transaction request.

2. The method of claim 1 wherein the transaction request is received via one of HTTP and FTP.

3. The method of claim 1 further including the step of determining whether a first transaction of the one or more transactions in the transaction request is a high risk transaction.

4. The method of claim 3 further including the step of, if the first transaction is determined to be a high risk transaction, requesting a release to process the first transaction from at least one releaser identified in the first database.

5. The method of claim 4 further including the step of receiving an indication from the at least one releaser to process the first transaction.

6. The method of claim 1 further including the step of determining whether the transaction request is interactive.

7. The method of claim 6 further including the step of, transmitting a message to one of the third party accounting software and a user to indicate receipt of the transaction request if the transaction request is not interactive.

8. The method of claim 6 further including the step of, transmitting a status message to one of the third party accounting software and a user after processing the one or more transactions in the transaction request if the transaction request is interactive.

9. A system comprising:
an entitlements database for storing information identifying at least one account, and at least one third party accounting software site associated with the account;
a transaction assessment engine configured to receive a transaction request from the at least one third party accounting software site, each transaction request including one or more banking transactions, the transaction assessment engine being also configured to validate the transaction request, and provide one or more status messages to the third party accounting software regarding the status of the one or more banking transactions;
a transaction database in communication with the transaction assessment engine configured to store information regarding the one or more banking transaction included in the transaction requests; and
a transaction processing engine for processing the one or more banking transactions.

10. The system of claim 9 further including a bank hosted website, wherein the bank hosted website is configured to permit a user to update the information stored in the entitlements database.

11. The system of claim 9 wherein the transaction assessment engine is configured to communicate with the at least one third party accounting software site via one of HTTP and FTP.

12. The system of claim 9 wherein the transaction assessment engine is further configured to determine whether a first transaction of the one or more banking transactions is a high risk transaction.

13. The method of claim 12 wherein the transaction assessment engine is further configure to transmit a release message to a user requesting permission to process the first transaction if the first transaction is determined to be a high risk transaction.

14. The system of claim 9 wherein the transaction assessment engine is further configured to determine whether the transaction request is interactive.

15. The method of claim 14 wherein the transaction assessment engine is further configured to transmit a status message to at least one of a third party accounting software site and a user to indicate receipt of the transaction request if the transaction request is not interactive.

16. The method of claim 14 wherein the transaction assessment engine is further configured to transmit a status message to one of the third party accounting software and a user after the one or more transactions in the transaction requests is processed if the transaction request is interactive.

17. A system comprising:
means for receiving a transaction request from a third party accounting software, the transaction request including one or more transactions;
means for verifying, based on information stored in a first database, that the transaction request is from a valid source;
means for storing information regarding the one or more transactions from the transaction request in a second database;
means for processing the one or more transactions; and
means for providing a response to the third party accounting software indicating a status of at least one transaction in the transaction request.
